(19) United States
(12) Patent Application Publication
(10) Pub. No.: US 2024/0304010 A1
(43) Pub. Date: Sep. 12, 2024

(54) METHOD AND ELECTRONIC DEVICE FOR DETECTING AI GENERATED CONTENT IN A VIDEO

(71) Applicant: SAMSUNG ELECTRONICS CO., LTD., Suwon-si (KR)

(72) Inventors: Sourabh Vasant Gothe, Belagavi (IN); Vibhav Agarwal, Bengaluru (IN); Jayesh Rajkumar Vachhani, Bengaluru (IN); Sourav Ghosh, Kolkata (IN)

(73) Assignee: SAMSUNG ELECTRONICS CO., LTD., Suwon-si (KR)

(21) Appl. No.: 18/609,887

(22) Filed: Mar. 19, 2024

Related U.S. Application Data
(63) Continuation of application No. PCT/KR2024/002900, filed on Mar. 6, 2024.

(30) Foreign Application Priority Data
Mar. 6, 2023 (IN) 202341014910
Oct. 4, 2023 (IN) 202341066576
Feb. 12, 2024 (IN) 202341014910

(51) Int. Cl. G06V 20/00; G06T 7/11; G06T 7/20; G06V 10/774; G06V 10/80; G06V 10/82; G06V 20/40

(52) U.S. Cl. CPC G06V 20/95; G06T 7/11; G06T 7/20; G06V 10/774; G06V 10/806; G06V 20/41; G06V 20/46; G06T 2207/10016; G06T 2207/20081; G06T 2207/20084; G06T 2207/30196; G06T 2207/30241; G06V 10/82

(57) ABSTRACT

A method for detecting artificial intelligence (AI) generated content in a video, includes: receiving the video comprising a plurality of frames; detecting, an object, a person, and a background in each frame; determining pixel-motion information of each pixel in each frame; determining a relationship among the object, the person, and the background and the corresponding pixel-motion information in each frame; determining one or more intrinsic properties of the object, the person, and the background in each frame based on the relationship among the object, the person, and the background and the corresponding pixel-motion information; detecting inconsistent motion of the object, the person, and the background in at least one frame of the video based on the one or more intrinsic properties of the object, the person, and the background; and indicating AI generated content in the at least one frame based on the detected inconsistent motion.

### CROSS-REFERENCE TO RELATED APPLICATIONS

This application is a continuation of International Application No. PCT/KR2024/002900, filed on Mar. 6, 2024, which is based on and claims priority to Indian patent application Ser. No. 202341014910 filed on Feb. 12, 2024, Indian Provisional Application No. 202341066576 filed on Oct. 4, 2023, and Indian Provisional Application No. 202341014910 filed on Mar. 6, 2023, in the Indian Patent Office, the disclosures of which are incorporated by reference herein in their entireties.

### BACKGROUND

### 1. Field

The present disclosure is related to image processing and data classification. More particularly the present disclosure is related to a method and electronic device for detecting Artificial Intelligence (AI) generated content in a video.

### 2. Description of Related Art

The comprehension of video is a fundamental issue in the field of computer vision, encompassing various tasks such as video tagging, action recognition, and video boundary detection. Mobile devices are becoming the primary source of global video consumption, with 92% of videos watched on such devices being shared with others. However, existing video models are limited in their focus on a predefined set of action classes and the processing of short clips to generate global video-level predictions. With the increasing quantity of video content, the number of action classes is expanding, and the predefined target classes may not cover all the classes completely. In response, the Generic Event Boundary Detection (GEBD) task was introduced, aiming to study the long-form video understanding problem through the lens of human perception. GEBD aims to identify class-agnostic event boundaries that are independent of their categories, including changes in subject, action, shot, environment, and object of interaction. The outcome of GEBD has the potential to benefit a wide range of applications, such as video summarization, editing, short video segment sharing, and enhancing video classification and other downstream tasks.

In related technologies, sophisticated deep learning techniques are employed to produce synthetic content, including images, audio, and text. Interestingly, such artificially generated content can often be indistinguishable from non-artificial content, prompting the need for methods to detect and inform users of the synthetic origin of this type of content.

In related methods, the identification of artificial content involves a subset scanning technique over generative model activations. A Machine Learning (ML) model is trained with input data to extract a group of activation nodes, from which anomalous nodes may be detected. The network structure is updated to include the extraction of activations from a discriminator layer. Group-based subset scanning is then applied over these activations to obtain anomalous nodes. The discriminator is responsible for distinguishing natural data from artificial data. This process may be repeated until a threshold is reached. However, the existing technique falls short in disclosing the computation of normalized patch-flow to detect subtle subject and action motion. The existing technique also lacks cross-modal feature fusion and relationship construction between visual and motion representations. Moreover, the detection of physical properties of objects such as floating, penetration, timing errors, angular distortions, gravity, or any other physical property is not disclosed.

The related method discerns the authenticity of a video featuring an individual's natural facial movements during speech. The technique employs audio analysis, including the tracking of lip movements, and a neural network that processes audio spectra to generate feature vectors representing cadence, pitch, tonal patterns, and emphasis. An analysis module subsequently detects any alterations made to the audio, indicating the presence of a fake video only if irregularities exist in both the spatial domain (e.g., checkerboard pattern blurriness) and the frequency domain (e.g., bright spots along the edges) through a discrete Fourier transform (DFT). However, this approach is limited to detecting facial movement irregularities through facial and speech feature vectors and does not account for normalized patch-flow computation to detect subtle subject and action motion. Moreover, the technique does not integrate cross-modal features fusion or establish relationships between visual and motion representations. Further, the methodology does not explore localizing the regions of physically implausible interactions for proper interpretation or analysis through disentangled latent features.

In related method, videos are classified as genuine or counterfeit by extracting facial features such as facial modalities and emotions, as well as speech features such as speech modalities and emotions. These modalities are then processed by first and second neural networks to create facial and speech modality embeddings. Additionally, third and fourth neural networks are utilized to generate facial and speech emotion embeddings. To model these multimodal characteristics and perceived emotions, a learning method employing a Siamese network-based architecture is disclosed. During training, a genuine video and a corresponding deepfake counterpart are inputted into the network to obtain modality and perceived emotion embedding vectors for the subject's face and speech. The embedding vectors are then utilized to compute a triplet loss function, which is employed to minimize the similarity between the modalities of the fake video and maximize the similarity between the modalities of the genuine video. However, the related method is limited to detecting only facial movement irregularities using facial and speech feature vectors. Furthermore, the computation of normalized patch-flow to detect minor subject and action motion is not performed, and cross-modal features fusion and relationship construction representations between visual and motion are not explored. Further, the related method does not localize the regions of physically implausible interactions for proper analysis through disentangled latent features.

A related approach for detecting forged face videos involves utilizing optical flow tracking. This method entails extracting facial features from the video dataset to be examined and creating frame images. Further, an optical flow tracking neural network is constructed and trained. The face video is then inputted into the neural network, and optical flow tracking is performed. Further, the optical flow tracking data is utilized in conjunction with a detection convolutional neural network to identify fake videos. However, this method is restricted to facial information and is therefore ineffective for non-human videos or videos lacking faces. Additionally, the method does not extract optical information from video patches, thereby hindering multi-object tracking and relation learning. Furthermore, the technique does not address the localization of inconsistencies in the video.

One related technique involves the generation of realistic human motions through the employment of a physics-guided motion diffusion model, known as PhysDiff. This model integrates physical constraints into the diffusion process. Additionally, the technique proposes a motion projection module based on physics that utilizes motion imitation within a simulator to project denoised motion from a diffusion step into a physically plausible motion. However, it should be noted that this method is limited to human motion and is not appropriate for explainable discrimination.

### SUMMARY

According to an embodiment of the disclosure, a method for detecting artificial intelligence (AI) generated content in a video is provided. The method may include obtaining, by an electronic device, the video comprising a plurality of frames. The method may include identifying, by the electronic device, at least one of object, person, or background in each frame of the plurality of frames of the video. The method may include identifying, by the electronic device, pixel-motion information of each pixel in each frame of the plurality of frames. The method may include identifying, by the electronic device, a relationship among the at least one of object, person, or background and the corresponding pixel-motion information in each frame of the plurality of frames. The method may include identifying, by the electronic device, one or more intrinsic properties of the at least one of object, person, or background in each frame of plurality of frames based on the relationship among the at least one of object, person, or background and the corresponding pixel-motion information. The method may include identifying, by the electronic device, inconsistent motion of the at least one of object, person, or background in at least one frame of the plurality of frames of the video based on the one or more intrinsic properties of the at least one of object, person, or background. The method may include displaying, by the electronic device, AI generated content in the at least one frame of the plurality of frames of the video based on the detected inconsistent motion of the at least one of object, person, or background in at least one frame of the plurality of frames of the video.

According to an embodiment of the disclosure, an electronic device for detecting artificial intelligence (AI) generated content in a video is provided. The electronic device may include one or more memories storing instructions. The electronic device may include one or more processors communicatively coupled to the memory. The electronic device may include the one or more processors which may be configured to execute the instructions to receive the video comprising a plurality of frames. The electronic device may include the one or more processors which may be configured to execute the instructions to identify at least one of object, person, or background in each frame of the plurality of frames of the video. The electronic device may include the one or more processors which may be configured to execute the instructions to identify pixel-motion information of each pixel in each frame of the plurality of frames. The electronic device may include the one or more processors which may be configured to execute the instructions to identify a relationship among the at least one of object, person, or background and the corresponding pixel-motion information in each frame of the plurality of frame. The electronic device may include the one or more processors which may be configured to execute the instructions to identify one or more intrinsic properties of the at least one of object, person, or background in each frame of plurality of frames based on the relationship among the at least one object, person, or background and the corresponding pixel-motion information. The electronic device may include the one or more processors which may be configured to execute the instructions to identify inconsistent motion of the at least one of object, person, or background in at least one frame for the plurality of frames of the video based on the one or more intrinsic properties of the at least one of object, person, or background. The electronic device may include the one or more processors which may be configured to execute the instructions to indicate AI generated content in the at least one frame of the plurality of frames of the video based on the detected inconsistent motion of the at least one of object, person, or background in at least one frame of the plurality of frames of the video.

According to an embodiment of the present disclosure, a computer-readable storage medium which is configured to store instruction is provided. The instructions, when executed by at least one processor of a device, may cause the at least one processor to perform the method corresponding.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A-1D illustrates a scenario in which artificial content is generated;

FIG. 2 is a block diagram that illustrates an electronic device for localizing inconsistent motion in the video, according to an embodiment of the present disclosure;

FIG. 3A is a detailed block diagram that illustrates localization of inconsistent motion in the video, according to an embodiment of the present disclosure;

FIG. 3B is a block diagram that illustrates estimation of patch-wise trajectory in the video frames, according to an embodiment of the present disclosure;

FIG. 3C is a block diagram that illustrates extraction of spatial information in the video frames, according to an embodiment of the present disclosure;

FIG. 3D is a block diagram that illustrates reconstruction of feature fusion and relationship, according to an embodiment of the present disclosure;

FIG. 4 is a block diagram that illustrates reconstruction of cross modal relation, according to an embodiment of the present disclosure;

FIG. 5 is a block diagram that illustrates inconsistency classification and localization of the video, according to an embodiment of the present disclosure;

FIG. 6 is a block diagram that illustrates authenticity identification of the video, according to an embodiment of the present disclosure;

FIG. 7 is a flow diagram that illustrates localizing inconsistent motion in the video, according to an embodiment of the present disclosure;

FIGS. 8A-8I illustrates a scenario of effectively communicating to the user about the presence of artificially generated content in the video, according to an embodiment of the present disclosure.

FIG. 9 illustrates an algorithm of FlowGEBD using pixel tracking (framewise mode), according to an embodiment of the present disclosure.

FIG. 10 illustrates an algorithm of FlowGEBD using optical flow normalization (patchwise mode), according to an embodiment of the present disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

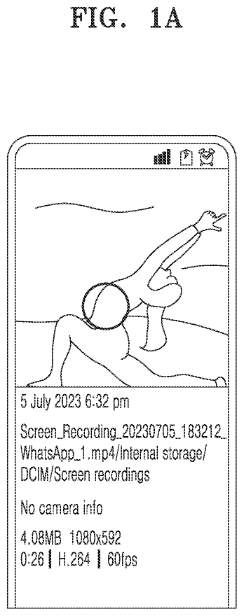

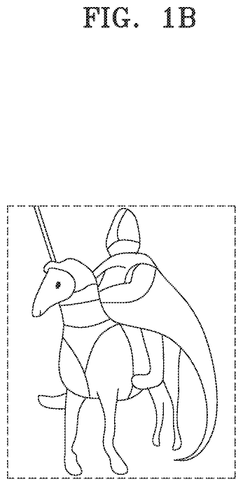

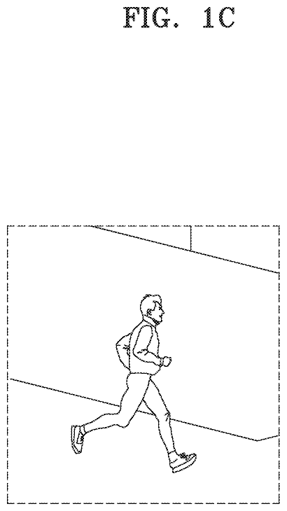

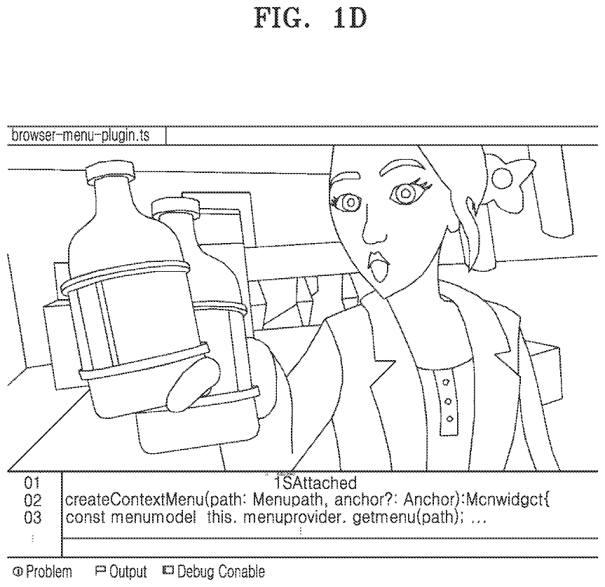

As understood by one or ordinary skill in the art, there are advanced deep learning techniques utilized to create synthetic content, including artificial images, audio, and text. This content may often be perceived by viewers as authentic, despite its artificial origins. For example, FIG. 1A displays inconsistencies and unrealistic lighting patterns resulting from the manipulation of a video frame, where an image of a person exercising is superimposed onto a sun image. Similarly, FIG. 1B and FIG. 1D depict video frames that defy the laws of physics, exhibiting interpenetrations (e.g., mixing together) and foot sliding, respectively. Also, FIG. 1C features a video frame containing synthetic content with perpetual motion and excessive energy. Hence, there is a need to determine the artificially generated content and localize the inconsistent motion in the videos.

The related technique does not consider identifying physical properties of objects such as floating, penetration, timing errors, angular distortions, gravity and the like in the video. Also, the related techniques do not disclose about the feature of localizing the regions of physically-implausible interactions for proper interpretation or analysis. Further, the related techniques are limited to facial information, therefore, it fails for the videos that do not have faces and non-human videos.

The embodiments of the present disclosure are directed to a method and an electronic device for detecting AI generated content in a video. The method includes, obtaining (e.g. receiving, downloading, retrieving), by an electronic device, the video comprising a plurality of frames. Further, the method includes identifying, by the electronic device, at least one of object, person or background in each frame of the plurality of frames of the video. Furthermore, the method includes identifying, by the electronic device, pixel-motion information of all the pixels in each frame of the plurality of frames. Thereafter, the method includes identifying, by the electronic device, a relationship among the at least one of object, person or background and the corresponding pixel-motion information in each frame of the plurality of frames. Moreover, the method includes identifying, by the electronic device, one or more intrinsic properties of the at least one of object, person or background in each frame of plurality of frames based on the relationship among the at least one of object, person or background and the corresponding pixel-motion information. Also, the method includes identifying, by the electronic device, inconsistent motion of the at least one of object, person or background in at least one frame of the plurality of frames of the video based on the one or more intrinsic properties of the at least one object, person and background. Furthermore, the method includes displaying (e.g. indicating, marking, representing), by the electronic device, AI generated content in the at least one frame of the plurality of frames of the video based on the inconsistent motion of the at least one of object, person or background in at least one frame of the plurality of frames of the video. In an embodiment, the ‘identifying’ action mentioned above or below can be replaced with ‘detecting’ or ‘determining’.

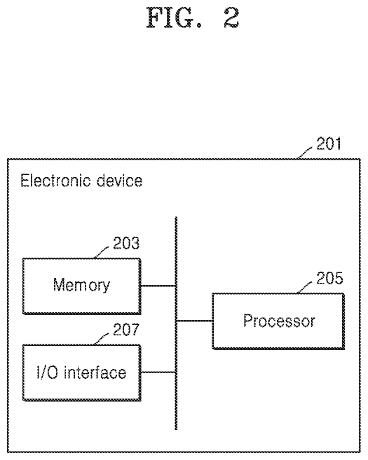

FIG. 2 is a block diagram that illustrates an electronic device for localizing inconsistent motion in the video, according to the embodiments of the present disclosure. According to one or more embodiments, the electronic device (201) may include a memory (203), a processor (205), and an Input/Output (I/O) interface (207). The electronic device (201) may be a device used directly by an end-user to communicate. For example, the electronic device (201) may include, but not limited to mobile device, laptop, desktop computer, tablet, or any other suitable electronic device known to one of ordinary skill in the art. In an embodiment, some of the actions performed by the processor (205) as shown below can be performed by a motion detector. In an embodiment, the motion detector may be interconnected to the processor (205), memory (203) and input/output interface (207) via a bus. In an embodiment, the motion detector of the electronic device (201) may communicates with the processor (205), the I/O interface (207) and the memory (203) to detect AI generated content in the video. The motion detector may be a hardware that is realized through the physical implementation of both analog and digital circuits, including logic gates, integrated circuits, microprocessors, microcontrollers, memory circuits, passive and active electronic components, as well as optical components.

Referring to the FIG. 2, the processor (205), memory (203), and input/output interface (207) may be interconnected to each other via a bus. The electronic device (201) may be configured to identify (e.g. detect, sense, notice) AI generated content in the video. Further, the processor (205) of the electronic device (201) communicates with the memory (203), and input/output interface (207). The processor (205) may be configured to execute instructions stored in the memory (203) and to perform various processes. The processor (205) may include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (203) of the electronic device (201) may include storage locations to be addressable through the processor (205). The memory (203) is not limited to a volatile memory and/or a non-volatile memory. The memory may store several images or videos received by the electronic device (201). In one or more examples, the memory may store spatial feature maps, patchwise trajectory estimation, fused feature maps, reconstructed feature maps, or any other suitable information known to one of ordinary skill in the art. Further, the memory (203) may include one or more computer-readable storage media. The memory (203) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories. The memory (203) can store the media streams such as audios stream, video streams, haptic feedbacks and the like.

In one or more examples, the I/O interface (207) may transmit the information between the memory (203) and external peripheral devices. The peripheral devices may be the input-output devices associated with the electronic device (201). The I/O interface (207) may receive at least one of videos, images from plurality electronic devices (201), through a wireless communication network.

In one or more examples, the processor (205) of the electronic device (201) may communicate with the I/O interface (207) and the memory (203) to detect AI generated content in the video. The processor (205) may be an hardware that is realized through the physical implementation of both analog and digital circuits, including logic gates, integrated circuits, microprocessors, microcontrollers, memory circuits, passive and active electronic components, as well as optical components.

In one or more examples, the processor (205) may obtain (e.g. receive, download, retrieve) a video that comprises a plurality of frames. The video may be a sequence of individual images or frames displayed in rapid succession to create the illusion of motion. Each frame may represent a still image. Further, the processor (205) may identify (e.g. detect, sense, notice) at least one of object, person, or background in each frame of the plurality of frames of the video. The objects, person or background may be herein referred to as spatial context of the video interchangeably. In one or more examples, the spatial context in the video may refer to semantics, relationships, positions, and arrangements of objects, scenes, or elements within the visual space of each frame. In one or more examples, the spatial context may encompass the spatial distribution of visual information and the contextual understanding of how different components within the frame relate to each other in terms of location, size, shape, and orientation. Furthermore, the processor (205) may identify (e.g. determine, figure out, confirm, decide) pixel-motion information of each pixel across the plurality of frames which are segmented into plurality of patches. In one or more examples, each patch of the plurality of patches may comprise one or more spatial context. The pixel-motion information in the video frame refers to the data that may describe the movement or displacement of pixels from one frame to the next in a sequence of video frames. Thereafter, the processor (205) may identify (e.g. determine, figure out, confirm, decide) a relationship among the at least one spatial context corresponding to the pixel-motion information using an AI model. In an embodiment, the relationship may be obtained (e.g. captured, computed, calculated) in abstract features (e.g., vectors) of a neural network, which is trained to extract relationship from trajectory features via attention. In one or more examples, the processor (205) may identify (e.g. determine figure out, confirm, decide) one or more intrinsic properties of the at least one of object, person, or background in each frame of the plurality of frames based on the determined relationship. The intrinsic properties may refer to inherent characteristics that are fundamental to each spatial context. For example, the intrinsic properties may include, but are not limited to, floating, penetration, perpetual motion, energy level, and angular distortions. The processor (205) may identify (e.g. detect, sense, notice) inconsistent motion in at least one object, person, or background within a frame of video, based on one or more intrinsic properties of said spatial context. For instance, inconsistent motion may be identified in the video frame when perpetual motion is observed in the spatial context. Further, the processor (205) may display (e.g. indicate, mark, represent) AI generated content in at least one frame of the plurality of frames of the video based on inconsistent motion of the at least one of object, person, or background in the at least one frame of the plurality of frames of the video. Additionally, the processor (205) may localize the spatial region within the video frame where the inconsistent motion is identified. This localization process may involve identifying and determining the position or location of the spatial context exhibiting such motion. In an embodiment, the motion detector may perform some of the actions performed by the processor (205).

Thus, the determination of the inconsistency in the video and localizing the inconsistency in the video may enable the user to know whether a video contains real content instead of the artificial generated content. In an embodiment of the present disclosure, a fusion feature and relationship construction may identify the relationship between the spatial context corresponding to the pixel-motion information. In one or more examples, with cross-modal relation reconstruction, it is possible to extract the physics properties of a spatial context and also utilize the physical properties to identify the inconsistency in the video.

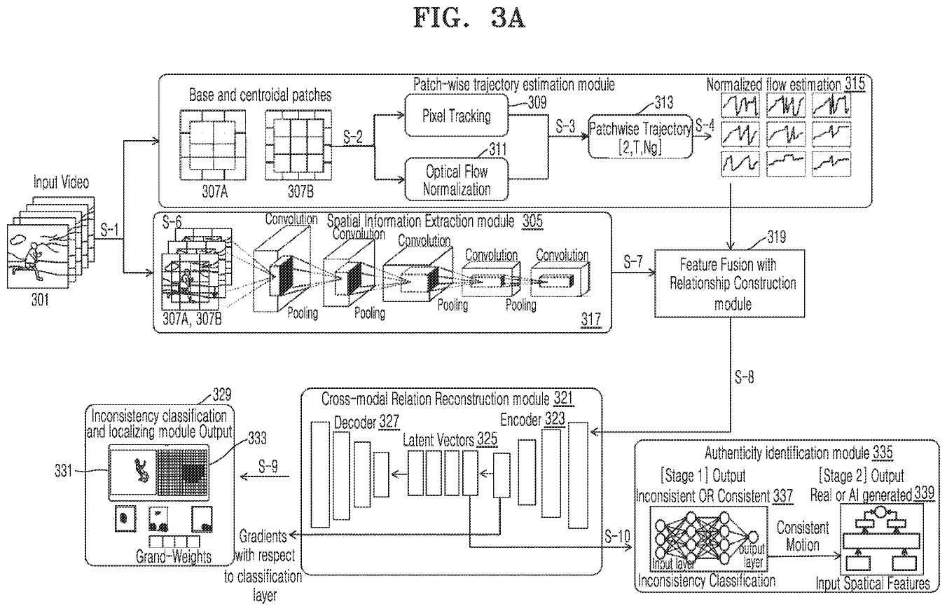

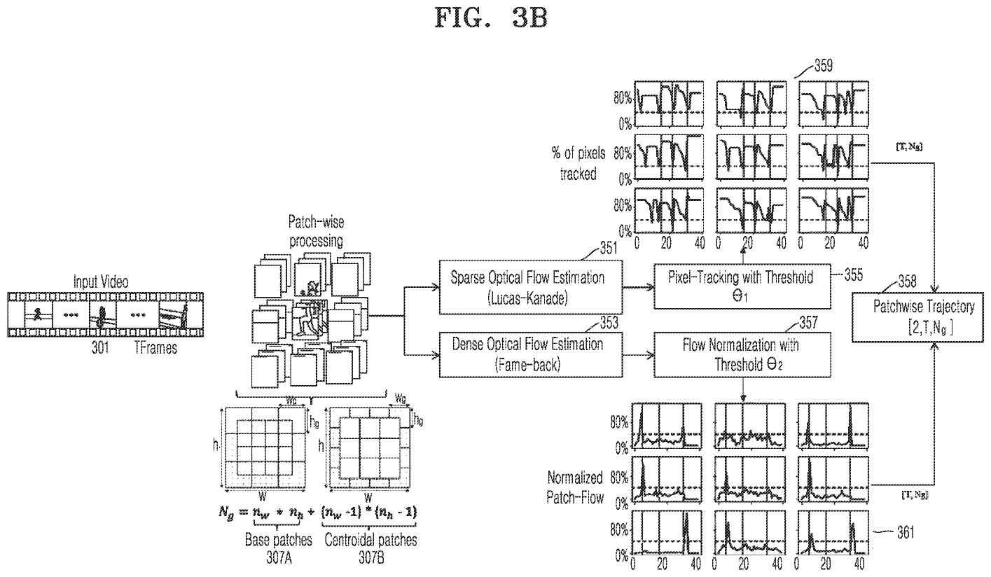

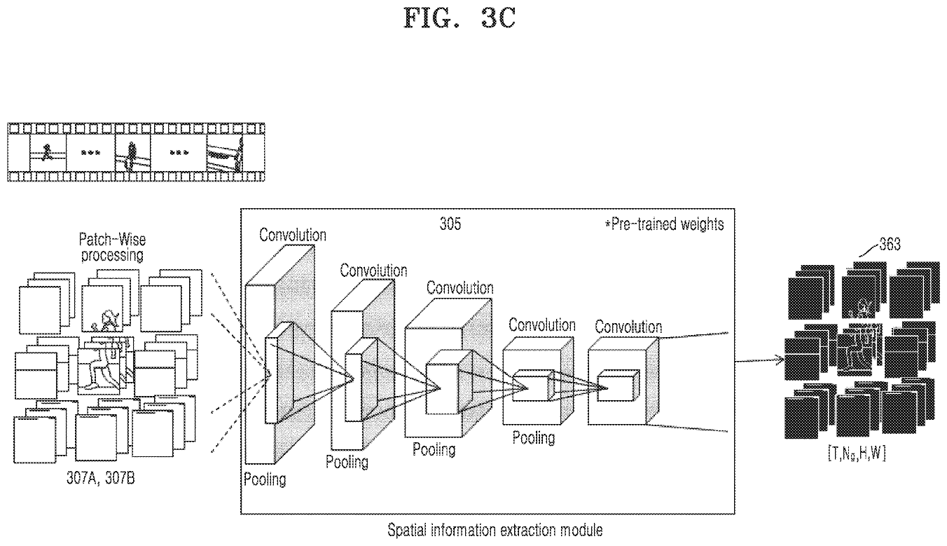

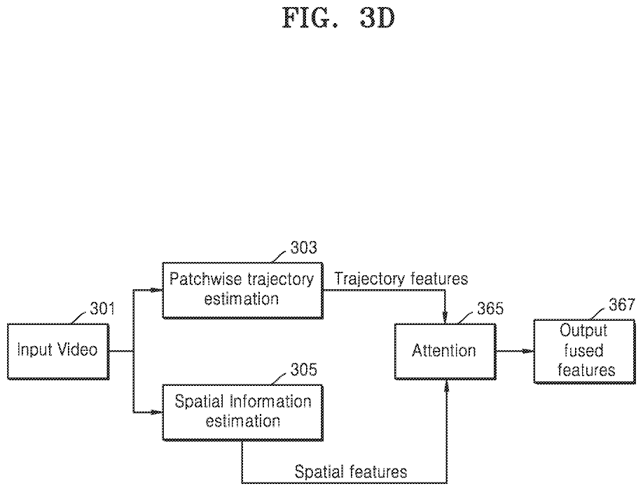

FIG. 3A is a detailed block diagram that illustrates identification (e.g. detection, confirmation) of AI generated content in the video, according to the embodiments of the present disclosure. As shown FIG. 3A, at step S-1, the input video (301) comprising a multitude of frames may be directed to the processor's (205) patch-wise trajectory estimation module (303) and spatial information extraction module (305). In one or more examples, the patch-wise trajectory estimation module (303) may divide (e.g. segment, separate, split) and obtain (e.g. extract, retrieve) each video frame of the input video (301) into a base patch and centroidal patch (307A, 307B). In one or more examples, the patch-wise trajectory estimation module may divide (e.g. segment, separate, split) the video into a base patch and a centroidal patch (307A, 307B) using a cropping technique and the like. In one or more examples, the base patches may be patches for which the frame is divided into equal parts in horizontal and vertical dimensions based on chosen width (n, w) and height (n,h) of a single patch. The number of base patches may be equated to (n_w×n_h). In one or more examples, the centroidal patches are the patches for which the frame is divided into patches such that each edge joins the centroids of the adjacent base patches. The number of centroidal patches may be equated to ((n_w−1)×(n_h−1)). Further, the segmented video frame may be subjected to pixel tracking (309) and optical flow normalization (311) in step S-2. This process may be applied to each patch of the video frame, where a sparse optical flow estimation method such as the Lucas-Kanade technique may be employed to estimate the motion of specific key features in each patch. However, it may not obtain (e.g. capture) the motion estimation of every pixel in a patch. Therefore, during the optical flow normalization (311), a dense optical flow estimation method such as Frane-back may be used to identify, determine and estimate the motion of every pixel in each patch of the segmented video frame. The result of the pixel-tracking (309) and the optical flow normalization (311) may be depicted in the form of a graph that includes the trajectory representing the motion of pixels. This trajectory obtained for each patch in the video frame may be referred to as a patch-wise trajectory (313). In step S-3, the patch-wise trajectories (313) may be obtained as a result of combining pixel-tracking (309) and the optical flow normalization (311) to form a normalized flow estimation (315). Further, in step S-4, the patch-wise trajectory estimation module (303) generates normalized flow estimation (315). Further, in step S-5, the normalized flow estimation (315) is fed into the feature fusion and relationship construction module (319).

At step S-6, the spatial information extraction module (305) may obtain (e.g. extract, retrieve) spatial context in each patch of the video frame. The spatial context may display (e.g. indicate, mark, represent) key visual information present in every patch of the video frame. For example, the key visual information may include, but not limited to an object, a person, and a background. The spatial information extraction module (305) may obtain (e.g. extract, retrieve) the spatial context using a pre-trained Convolutional Neural Network (CNN) model. The spatial context in each patch of the video frame may be outputted in the form of feature maps.

Furthermore, at step S-7, the spatial information extraction module (305) generates feature maps and then transmitted to the feature fusion with relationship construction module (319). A latent relationship between the spatial context and pixel-motions may be derived by combining or fusing the feature maps and normalized flow estimation (315). The feature fusion with relationship construction module (319) may leverage bi-modal features via attention mechanism to derive the latent relationship. The fused feature maps may represent the derived latent relationship.

Upon deriving the latent relationship, at step S-8, the latent relationship may be inputted to a cross-modal relation reconstruction module (321). The cross-modal relation reconstruction module (321) may include an encoder (323), latent vectors (325) and an decoder (327). In one or more examples, the encoder (323) may be trained to reconstruct the input features while learning the latent vectors of the at least one spatial context from the video frame. For example, the latent vectors may include but not limited to an energy, force, and pressure. The latent vectors (325) are used to derive the intrinsic properties of the at least one spatial context in the video frame. Further, the decoder (327) may generate a reconstructed fused feature maps by decoding the compressed fused feature map.

Furthermore, at step S-9, the encoded latent vectors from the cross-modal relation reconstruction module (321) may be transmitted to the inconsistency classification and localization module (329). The inconsistency classification and localization module (329) may determine whether the at least one spatial context in the reconstructed feature maps of the video frame is consistent or inconsistent. The latent vectors may be obtained from the encoder part of the cross-modal relation reconstruction module (321) which is pre-trained to determine whether the video frame is consistent or inconsistent. The pre-trained frozen (e.g., unchanged or static) network, may determine the intrinsic properties of the at least one spatial context in the video frame in the form of latent vectors which are physics informed features learned/trained during reconstruction process. Further, these latent vectors may be passed through Multi-Layer Perceptron network to classify the inconsistency. In one or more examples, during the training of Multi-Layer Perceptron network classifier, the pre-trained latent encoder network may be frozen (e.g., unchanged or static). The video frame, when determined to be consistent, may indicate that there is no artificially generated content in the video frame. Similarly, when the video frame is determined to be inconsistent, the video frame may indicate the presence of artificially generated content within the video. Once the inconsistency is determined, a region at which the inconsistency is present in the video frame may be determined. Moreover, the localization of the inconsistent video frame may be performed by computing a gradient with respect to the feature maps obtained during the spatial information extraction module (305) and the identifying a class activation map of the video (331). Ultimately, the classification and localization module (329) may localize the patch region of each frame (333) in the at least one video frame with inconsistencies.

Moreover, when the video frame is determined to be consistent, at step S-10, the cross-modal relation reconstruction module (321) may input the generated spatial feature maps to an authenticity identification module (335). Further, the authenticity identification module (335) may determine whether the video frame generated is a real or artificially generated content using a transformer based network. Ultimately, upon the determination, an indication of the video frame being real or artificially generated content may be provided to the users in the electronic device (201). FIG. 3B is a block diagram that illustrates estimation of patch-wise trajectory in the video frames, according to an embodiment of the present disclosure. As shown in FIG. 3B, consider an input video (301) that may be received by the patch-wise trajectory estimation module (303) of the electronic device (201) where the input video comprises plurality of frames. For example, consider the input video comprises “T” frames. In one or more examples, each frame “f” may comprise a width “w” and a height “h”. Further, the input video (301) may be segmented into base patches (307A) and centroidal patches (307B). The outer squares may represent the base patches (307A) and the inner overlapping squares may represent the centroidal patches (307B). Thus, a single patch may be a summation of the base patch (307A) and the centroidal patch (307B). Therefore, the total number of patches (Ng) for a frame may include both the base patches (307A) and centroidal patches (307B) as shown in below equation 1:

$$Ng = ( nw * nh ) + ( ( nw - 1 ) * ( nh - 1 ) ) . \qquad Eq . ( 1 )$$

The total number of base patches for the frame having the height “h” and the width “w” may be represented as (nw*nh). Similarly, the total number of centroidal patches for the frame having the height “h” and width “w” may be represented as (nw−1)*(nh−1).

Furthermore, the pixel-tracking (355) and flow normalization (357) may be performed on every patch (Ng) of each frame “f”. The pixel-tracking (355) may be performed using a sparse optical flow estimation (351). For example, the sparse optical flow estimation (351) may include, but is not limited to, the Lucas-Kanade optical flow method. During the pixel-tracking (355), only the flow motion of some of the pixels among all the pixels in the patch may be obtained. The flow motion of the pixels in each of the patch may be captured using a trajectory in a graph (359). The sudden fall of the pixels in the trajectory represented in the graph (359) may indicate that there can be a sudden change in the motion of the object or some change in the at least one spatial context or loss of some pixels in the patch and the like. In one or more examples, the level at which the sudden drop is observed considered to be significant enough to mark spatial change in the patch of the frame may be represented as threshold θ1. Similarly, the flow normalization (357) may be performed using the dense optical flow estimation (353). For example, the dense optical flow estimation (353) may be performed using a Gunnar Farnebacks technique. In the flow normalization (357) the flow motion of every pixel in each patch of every frame may be determined. Further, the maximum value from the flow motion of every pixel in the patch may be derived. The flow motion of every pixel in each patch may be captured as a trajectory and is represented in the graph (361). In one or more examples, the sudden spikes or crests in the flow motion of the pixels represented in the graph (361) may indicate the change in the motion of the at least one spatial context in the frame or an occurrence of an event. For example, when the sudden change in the motion of the object is encountered, a sudden dip or raise in the trajectory of the graph may be seen. In one or more examples, the level at which the sudden drop or raise is observed may be represented as threshold θ2. For example, when a drop or raise in a flow motion exceeds the threshold θ2, it may be determined that a sudden motion has been detected.

Furthermore, patch-wise trajectory estimation module (303) may concatenate the trajectory graph (359) obtained by performing the pixel-tracking (335) and the trajectory graph (361) obtained by performing the flow normalization to obtain a patch-wise trajectory (363) for each patch (Ng) of every frame (f) from plurality of frames (T).

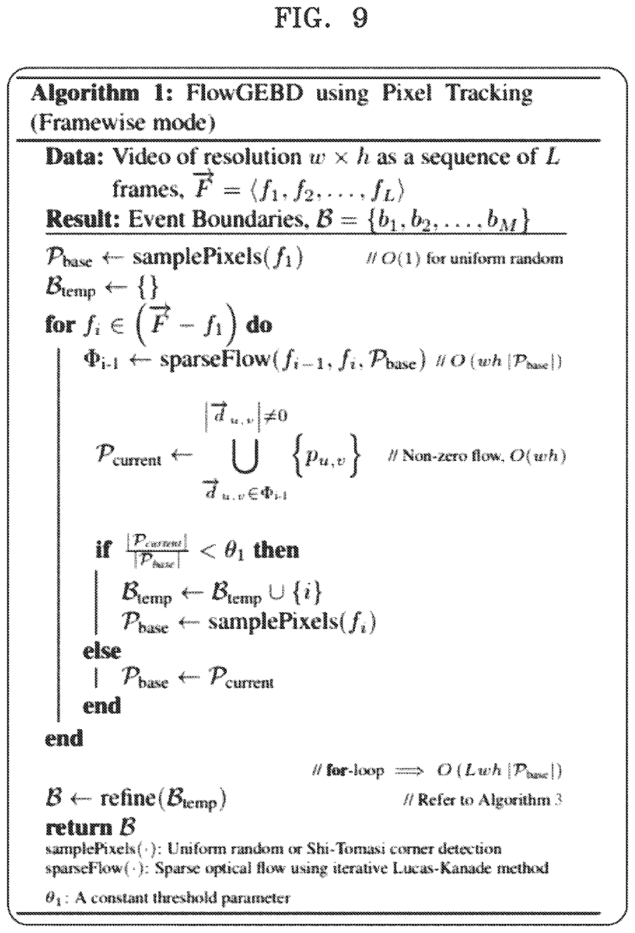

In an embodiment, the pixel-tracking (335) in every patch of each frame may be performed using the Flow GEBD technique shown in FIG. 9.

GEBD in video maps a sequence of L frames, {f1, f2, . . . , fL} (that may also be represented as [symbol] ∈F), and identifies a set of timestamps {b1, b2, . . . , bM} (=B [symbol] ), that denote the event boundaries. Based on these parameters, it follows that M≤L, and, in one or more examples, ∀bi∈−B, ∃j| (bi≡fj). Thus, GEBD task may be formulated as T, where T: F→B.

In one or more examples, each frame f of width w and height h comprises of a 2-dimensional matrix of pixels, pu, v, where u, v∈Z+(positive integers), u∈[1,w], and u∈[1, h]. In the GEBD technique, the luminance information of pixels may only be considered. Hence, pu,v can be represented as a real number (pu,v∈R), 0≤pu,v≤1.

According to one or more embodiments, optical flow is a measure of how the image data seen in one pixel, pu,v, changes position across consecutive frames. Thus, for each frame fi with a subsequent frame fi+1, the optical flow Φ i can be [symbol] as a 2-dimensional matrix of displacement vectors, du, v, which may indicate that the horizontal and vertical displacement that the image in pixel pu, v undergoes between frames fi and fi+1.

In one or more examples, a patch derived from frame f, gf, consists of a contiguous subset of the frame pixels. More specifically, patch gf (u, v, wp, wh) consists of all pixels, pi, j∈f, where i, j∈Z+, i∈[u,wp) and j∈[v, hp). We denote the set of all such patches in frame f as Gf.

In technique 1 as shown above, initially the consider two frames (fi−1, fi) along with number of pixels in the initial frame (pbase) is provided as the input to the sparse optical flow estimation (351). The input to the sparse optical flow estimation (351) is represented as shown in equation 2:

$$Φ i ← Sparseflow ( fi - 1 , fi , pbase ) \qquad Eq . ( 2 )$$

Further, the sparse optical flow estimation may determine for a non-zero value between the two inputted frames (fi−1, fi, pbase). The non-zero displacement value may indicate the pixels that are present in any one of the frame fi−1, or the frame fi with respect to the all pixels that was present in the phase. Further, the number of the pixels with non-zero displacement in the current frame may be compared with the number of pixels in the initial frame. When the ratio of the number of pixels between the current frame and the initial frame falls below a predefined threshold θ1, then the technique may determine that there can be sudden change in the motion of the at least one spatial context or change in the scene. Further, the current frame may be resampled. Furthermore, a new set of frames may be taken as the input and the process continues to track the motion of the pixels between every patch of each frame of the video and also to track the motion of pixels between the frames.

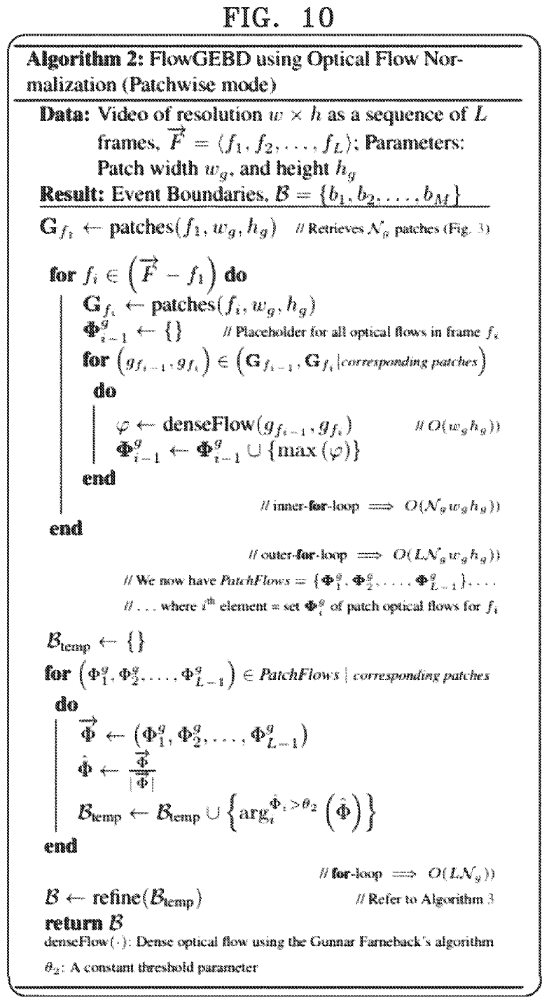

Similarly, the flow normalization (357) in every patch of each frame is performed using the Flow GEBD technique shown in FIG. 10.

In technique 2 of the GEBD method, as shown above according to one or more embodiments, all the patches (Ng) of the first frame may be provided as the input to the flow normalization (357) as shown in (Gf1). Further, a dense flow between each patch (gfi−1,gfi) of the frame may be obtained. The motion of each pixel in every patch may be determined in the dense optical flow estimation. Further, a maximum pixel value among all the pixel locations in a patch may be obtained. Similarly, the process may be repeated for every frame of the input video (301). Further, each patch of every frame may be compared with corresponding every patch of all every other frames of the input video to determine the motion or change between the frames of the input video. For example, there are 5 frames and every frame may be divided into 9 patches. The maximum value of each patch in all the 5 frames may be obtained. Further the max value of the first patch of all the 5 frames may be compared with each other to determine the motion of the at least one spatial content between all the 5 frames. Similarly, the max value of a second patch of all the 5 frames may be compared with each other. Thus, every patch of the frame may be compared with a corresponding patch of all other frames of the input video. Further, the obtained values of each patch of every frame may be normalized to determine the trajectory of the motion between the frames in the input video (301) represented as the graph (361). In one or more examples, the level at which the maximum patch flow may be considered to be significant enough to mark spatial change in the patch of the frame can be represented as threshold θ2. As a result of flow normalization (357), a very minute change or between the frames of the input video may be determined that further leads to the precise detection of the at least one spatial context in the input video (301).

FIG. 3C is a block diagram that illustrates extraction of spatial information in the video frames, according to the embodiments of the present disclosure.

As shown in FIG. 3C, the input video (301) is divided into a plurality of patches, where the plurality of patches may comprise the base patches (307A) and the centroidal patches (307B). Further, the plurality of the base patches and centroidal patches (307A, 307B) may be inputted to the spatial information extraction module (305). The spatial information extraction module (305) may identify (e.g. detect, retrieve) the at least one spatial context in the plurality of patches of the frame. The at least one spatial context may include, but not limited to, an object, a person, and a background in each patch of every frame of the input video (301). The spatial information extraction module (305) may identify (e.g. detect, retrieve) the at least one spatial context using the CNN model. The CNN model may include a plurality of convolution layers and pooling layers. The convolutional layers may be designed to recognize spatial semantics in each frame and also capture temporal features across frames of the input video (301). In one or more examples, the pooling layers may downsample the temporal dimensions of the plurality of frames in the input video (301). The spatial semantics and the temporal features obtained by CNN model may be represented in the form of the spatial feature maps (363). Each intermediate layer of the CNN model may provide the spatial feature maps (363). The spatial feature maps may be obtained for each patch of every frame of the input video (301). Thus, the spatial feature maps (363) may be obtained for all (Ng) number of patches of all the “T” frames having the height (H) and width (W), which is represented in the form of [T, Ng, H, W]. Further, the spatial information extraction module (305) may identify (e.g. detect, retrieve) the at least one spatial context from the spatial feature maps (363). The spatial feature maps (363) may provide visual patterns and information related to the arrangement, appearance, relationship of the objects within each frame and the like. In one or more examples, the spatial information extraction module (305) may derive distinguishing characteristics, positions, orientations, movements of the objects within each frame from obtained spatial feature maps (363).

FIG. 3D is a block diagram that illustrates reconstruction of feature fusion and relationship, according to the embodiments of the present disclosure. The feature fusion and relationship construction module (319) inputs the pixel-motion information obtained by the patch-wise trajectory estimation module (303) and the at least one spatial context obtained by the spatial information extraction module (305) to an attention based neural network (365). In one or more examples, the attention based neural network ( [symbol] ial feature maps (363) and the patch-wise trajectory (358) to obtain the relationship between the at least one spatial context and the motion associated with the spatial context. As a result of the combination, a fused feature map (367) or a fused representation of all patches for t frame fₜ is obtained. In one or more examples, the combination of the trajectory features (mₜ) of all patches for t frame from patch-wise trajectory (358) and the at least one spatial features of all patches for t frame (vₜ) from the spatial feature maps (363) is as shown below equation 3:

$${f}_{t} = {α}_{t}^{v} {v}_{t} + {α}_{t}^{m} {v}_{t} \qquad Eq . ( 3 )$$

where the weight value (αt) is determined using the below equation 4:

$${α}_{t}^{n} = \frac{exp ( {h}_{t}^{n} )}{{Σ}_{n ∈ ( v , m )} exp ( {h}_{t}^{n} )} \qquad Eq . ( 4 )$$

Further, hₜ^{v} and hₜ^{m} represent a scoring function to derive a quality relationship scores for the spatial and motion modality based on the spatial features and the trajectory features. In one or more examples, mₜ represents the trajectory features of all the patches (Ng) for the T frame and the vₜ represents the spatial features of all the patches (Ng) for the T frame. Further the fₜ represents the fused features of all the patches (Ng) for the T frames. Further, at represents the attention weights of the spatial features and the trajectory features.

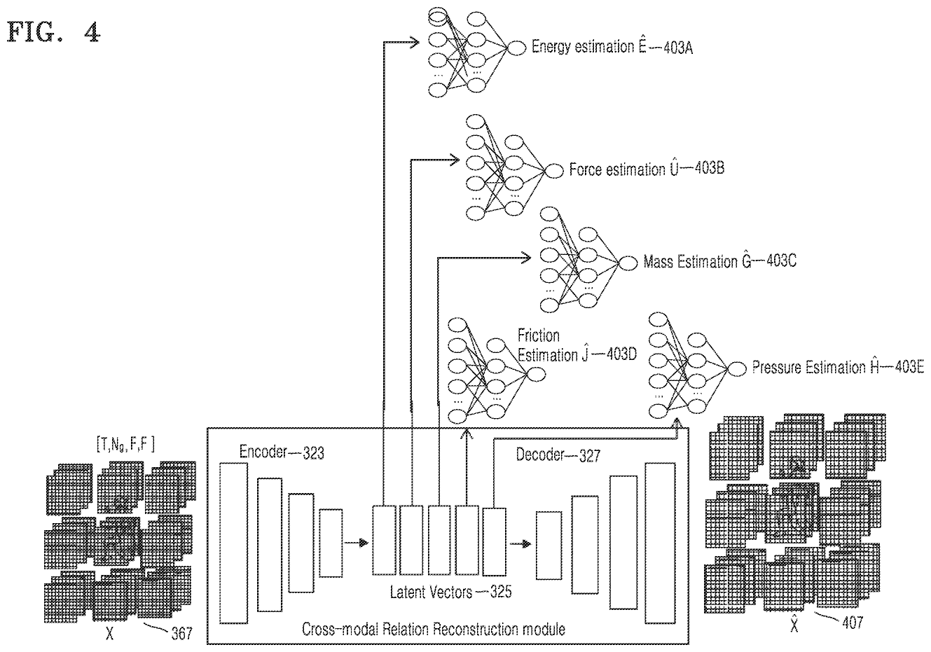

FIG. 4 is a block diagram that illustrates reconstruction of cross modal relation, according to an embodiment of the present disclosure. As shown in FIG. 4, the fused feature maps (367) obtained by the feature fusion and relationship construction module (319) may be inputted to the cross-modal reconstruction module (321). The cross-modal reconstruction module (321) may use a neural network that comprises an encoder (323) and decoder (327) to reconstruct the features obtained in the fused feature maps (367). Upon receiving the fused feature maps (367), the encoder (323) may compresse or encode the fused feature maps (367). During encoding, the higher dimensions feature of the fused feature maps may be reduced to lower dimension features. The low dimensional features may comprise the latent vectors (325). The latent vectors (325) should contain all the information of the input fused feature map (367) such that when decoded the input fused feature map (367) is reconstructed. Also, the latent vectors (325) should contain detailed information of the video frame. Each of the latent vectors (325) is trained using an AI model to predict some of the properties of the object. In an embodiment, the AI model may include an encoder that determines the relationship in a form of a fused feature map by fusing the information of the at least one of object, person, or background in each patch from each frame of the plurality of frames of the video and the pixel-motion information of the at least one of object, person, or background from the corresponding patch from each frame across the plurality of frames of the video. In an embodiment, the AI model may include one or more latent vectors that learns by training the encoder of AI model to predict the physical properties of the at least one of object, person, or background detected in the fused feature map. The one or more latent vectors comprise at least one of an energy, a force, a mass, a friction, or a pressure of the at least one of object, person, or background. For example, the properties of the object may include, but not limited to, energy, velocity, mass, friction and the like. For example, consider the first latent vector may be trained using an AI model to estimate the energy (403A) of the at least one spatial content in the fused feature map (367). Similarly, the second latent vector may be trained using an AI model to estimate the force (403B) of the at least one spatial content in the fused feature map (367). The third vector may be trained using an AI model to estimate mass (403C) of the at least one spatial content in the fused feature map (367). The fourth vector and fifth vector may be trained using an AI model to estimate friction (403D) and pressure (403E) respectively. Thus, each of the latent vector may hold a detailed information of one of the physical properties for which it was trained. Upon detecting, the low dimensional features of the fused feature maps (367) may be forwarded to the decoder (327). The decoder (327) may decode the encoded fused feature map to obtain the reconstructed feature map (407). Furthermore, a total loss may be determined based on the reconstructed feature maps (407) and the latent vectors (325) using the below equation below equation 5:

$$Total Loss = {L}_{overall} = {\vert X - \hat{X} \vert}_{2} + {λ}_{1} {\vert E - \hat{E} \vert}_{2} + {λ}_{2} {\vert U - \hat{U} \vert}_{2} + {λ}_{3} {\vert G - \hat{G} \vert}_{2} + {λ}_{4} {\vert J - \hat{J} \vert}_{2} + {λ}_{5} {\vert H - \hat{H} \vert}_{2} … + {λ}_{i} {\vert {k}_{i} - {{k}^{⌣}}_{i} \vert}_{2} \qquad Eq . ( 5 )$$

As shown in equation 5, for the energy estimation, Ê is predicted energy, and E is ground Truth value. Similarly, for force estimation, Û is predicted force, and U is ground Truth value for force. For mass estimation, Ĝ is predicted mass, and G is ground Truth value for mass. For friction estimation, Ĵ is predicted friction, and J is ground Truth value for friction. For pressure estimation, Ĥ is predicted pressure, H is Ground Truth value for pressure, X is Input, \hat{X} is Reconstructed input (Predicted), and λ (lamda) is regularization term for each downstream task.

During the reconstruction, the estimated physical properties in the latent vectors may indicate whether the spatial context in the at least one fused feature maps (367) is excessive or normal. This total loss function may enable all the latent vectors to be able to represent particular physics property (mass, energy etc.) by backpropagating the regularized loss, for example, the difference between the predicted (Ê) and groundtruth (E) property during training. For example, based on the given video, the latent vector may determine if any spatial context exhibits the excessive energy than normal energy required to be natural. Similarly, the value of each of the physical properties of the at least one spatial context may be determined to indicate presence of unnatural physical properties in the input video. Similarly, the value of all the physical properties of the at least one spatial context may be determined to indicate presence of excessive physical properties in the input video.

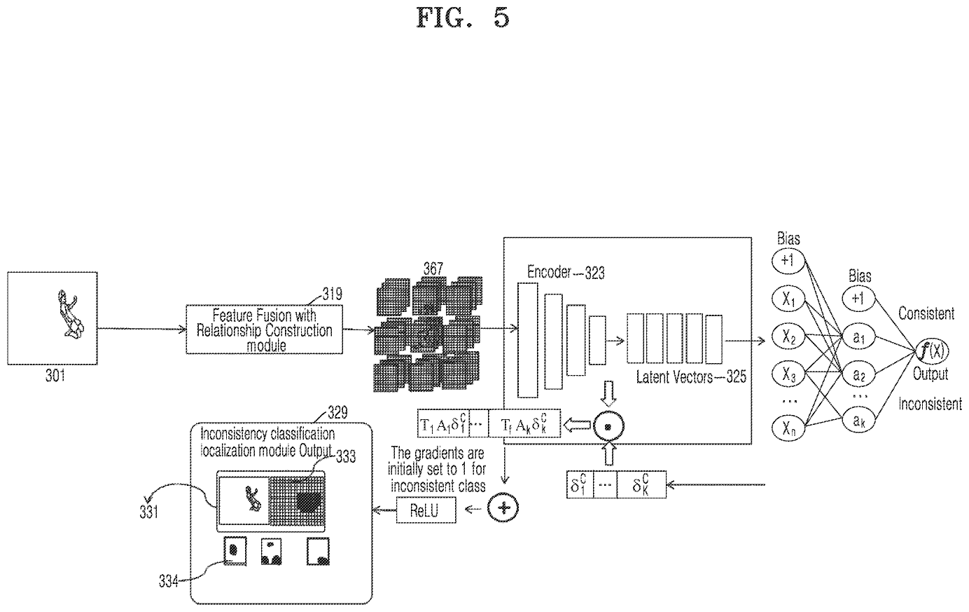

FIG. 5 is a block diagram that illustrates inconsistency classification and localization of the video, according to the embodiments of the present disclosure. The inconsistency classification and localization module (329) may receive a latent vector as an input from the cross-modal relation reconstruction module (321). The latent vectors may be obtained from the encoder (323) of cross-modal relation reconstruction module (325) (e.g., first half of the network). Further, during the training of the inconsistency classification and localization module (329), the pre-trained encoder from the cross-modal relation reconstruction is frozen (e.g., unchanged). Furthermore, the same trained network may be reused and frozen (e.g., unchanged) by the inconsistency classification and localization module (329). Furthermore, the inconsistency classification and localization module (329) may determine whether the reconstructed feature maps are consistent or inconsistent based on the latent vectors (403). The determination of the consistency and inconsistency may be performed using an AI model. The AI model may extract the information from the latent vectors (403) and may determine whether an excessive physical property is present in the reconstructed feature maps (407). Upon extracting the information from the latent vectors (325), when the AI model determines to have excessive properties in the reconstructed feature map, then the AI model may provide an output being inconsistent. Similarly, when there are no excessive physical properties determined in the reconstructed feature maps, then the AI model may provide an output being consistent. Once, the inconsistency is determined, then the localization of the inconsistency may be performed. For localization, the inconsistency classification and localization module (329) may take the intermediate feature maps (Aₖ) with low dimensions of the reconstructed feature map generated by the layers of the encoder as one of the inputs. In one or more examples, the output of AI model (δ₁^{c}, δₖ^{c}) that determined the inconsistency may be taken as another input for the localization. Furthermore, the inconsistency classification and localization module (329) may identify which of the intermediate feature maps that led to the decision of the inconsistency. In an embodiment, the inconsistency classification and localization module (329) may identify the specific patch in the intermediate feature maps that led to the decision of inconsistency. The identification may be performed by backtracking the AI model until the layers of the CNN model. For example, the specific patches of each frame (334) at which the inconsistency of the video (331) may be indicated in the form of normalized feature map. The localization of the inconsistency in the frame is determined as the gradient between the category (e.g., consistent or inconsistent) output score Sc and the intermediate feature map Aₖ using the below equation 6 and equation 7:

$${δ}_{k}^{c} = \frac{\partial {s}_{c}}{\partial {A}_{k}} \qquad Eq . ( 6 )$$

$${G}^{c} = ReLU ( {\sum }_{f} {\sum }_{k} {T}_{f} {A}_{k} {δ}_{k}^{c} ) \qquad Eq . ( 7 )$$

Further, δₖ^{c} denotes the weight of the kth feature map in fth frame and Gc is the normalized feature map Thus, the inconsistency classification and localization module (329) justify the region and the relationship that caused the decision of being consistent or inconsistent in the reconstructed feature map.

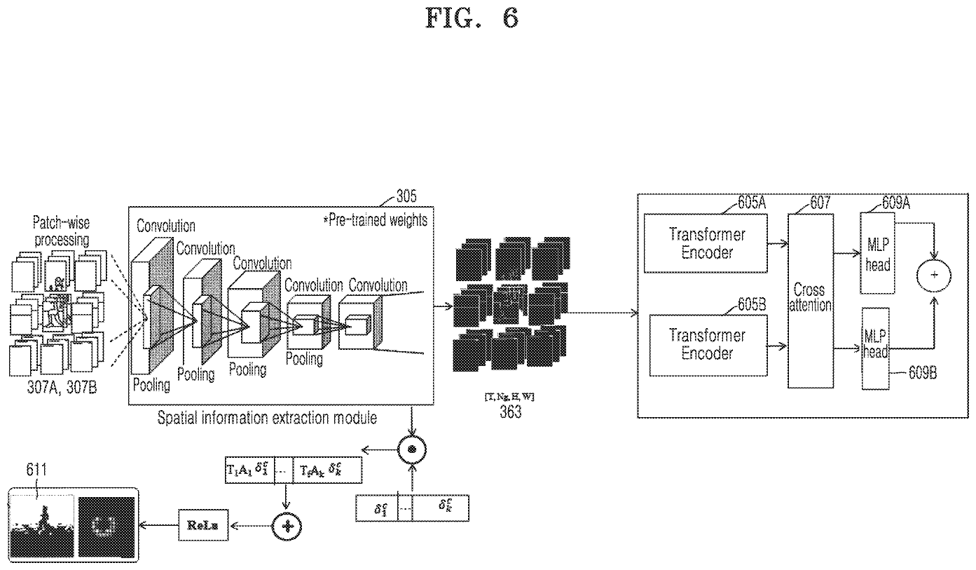

FIG. 6 is a block diagram that illustrates authenticity identification of the video, according to an embodiment of the present disclosure. Once consistency is determined by the inconsistency classification and localization module (329), the spatial feature maps (363) may be inputted to the authenticity identification module (335). The authenticity identification module (335) may input the spatial feature maps (363) to transformer encoder based network (605). The transformer encoder based network (605) determines the spaces between the pixels in each patch of the frame for indicating the consistency or inconsistency. In one or more examples, the transformer encoder based network (605) may determine the consistency or inconsistency only using the at least spatial context present in the plurality of frames of the input video (301). Moreover, the transformer encoder based network (605) may output the visual tokens from different patch-sized branches that are combined via cross attention (607). The determination performed by the transformer encoder based network (605) may be a double check or an authentication of the input video (301) being determined to be consistent. As a result of determination being inconsistent, the transformer encoder based network (605) may localize the region of inconsistency in each frame of the input video (301). The localized inconsistent patches in the frame of the input video (301) may be represented in the form of normalized feature map (611).

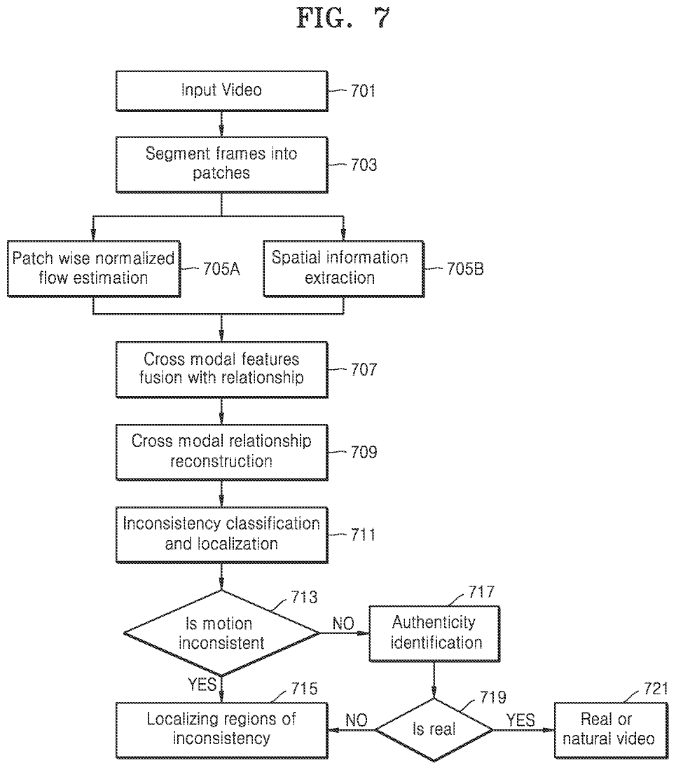

FIG. 7 is a flow diagram that illustrates localizing inconsistent motion in the video, according to the embodiments of the present disclosure.

At operation 701, an input video may be received by the electronic device. The input video may be received from one or more electronic devices that can be communicated through the network. The input video may include plurality of frames.

Further, at operation 703, each frame of the plurality of frames may be segmented into plurality of patches. In an embodiment, each patch may include the base patch and the centroidal patch.

At operation 705A each of the segmented frame comprising the plurality of patches may be inputted to the patch-wise trajectory estimation module (303). The patch-wise trajectory estimation module (303) may perform the pixel tracking (309) and the optical flow normalization (311) for each patch in the segmented frame. In the pixel tracking (309) the motion of pixels in each patch of the frame may be tracked using a sparse optical flow estimation (251). In the optical flow normalization (311), the motion of every pixel in each patch of the frame may be tracked using a dense optical flow estimation (353). Further, the trajectory motion of the pixels derived from sparse optical flow estimation (251) and the dense optical flow estimation (353) may be combined to form patch-wise trajectory (358). Thus, the patch-wise trajectory estimation module (303) may track the trajectory of the motion of the pixels between the patches in each frame and also the motion between the frames.

At operation 705B, each of the segmented frame comprising the plurality of patches may be inputted to the spatial information extraction module (305). The spatial information extraction module (305) may extract the at least one spatial context from each patch of the segmented frame using a CNN model (317). The at least one spatial context may include, but not limited to, an object, a person, and a background. For example, for an input video of a person playing a football may include an object such as a ball, goalpost etc. The background may include a lawn, a dark screen etc.

At operation 707, the patch-wise trajectory features (358) may be combined with the at least one spatial context to derive the relationship between the motion of the pixels and the at least one spatial context. For example, the input video may be of a person playing football, when an input video for one of the patches in the video frame may have a relationship where the motion of the pixels can be determined to be man, grass, ground and the spatial context can be determined to be head, ground. Thus, the relationship between the pixel motion and the spatial context may be derived as Visual (Head, ground)+Motion (man, grass/ground). The result of combination of the pixel motion and the at least one spatial context may be represented in the form of fused feature maps (367).

At operation 709, the fused features maps (367) may be reconstructed using the cross-modal relationship reconstruction module (321). The cross-modal relationship reconstruction module (321) may reconstruct the fused feature map using neural network. The neural network may comprise the encoder (323), the latent vectors (325) and the decoder (327). The encoder (323) may further reduce the resolution of the fused feature maps (367) until the latent vectors (325) are obtained. The latent vectors (325) may include the detailed information of the spatial features present in the frame of the input video (301). Further, each of the latent vectors may be trained to derive the physical properties associated with the spatial context in each patch of the fused feature map. Upon deriving the physical properties, the fused feature map (367) are decoded using the decoder (327) to obtain a high resolution reconstructed feature map (407).

At operation 711, the classification of inconsistency and localization of the reconstructed feature map (407) may be performed by the inconsistency classification and localization module (329). The inconsistency classification and localization module (329) may classify whether the frame of the input video is consistent or inconsistent based on the latent vectors (403) and the reconstructed feature map (407). The inconsistency classification and localization module (329) may back track the reconstructed feature maps (407) to determine the intermediate feature maps that lead to the determination of inconsistency based on the physical properties determined in the at least one spatial context.

Further, at operation 713 the inconsistency classification and localization module (329) may determine whether the motion of each spatial context in each patch of the segmented frame is consistent or inconsistent.

When the motion is determined to be inconsistent, then at operation 715, the inconsistency classification and localization module (329) may localize or determine the region in every patch of the frame for where the inconsistency is determined.

However, when the motion is determined to be consistent, at operation 717, authenticity identification of the reconstructed feature map (407) may be performed. The authenticity identification module (335) may produce the binary classification (e.g. real or AI generated). The authenticity identification module (335) may input the spatial feature maps (363) to an AI model to determine the consistent or inconsistent in the motion of the at least one spatial context. In an embodiment, the AI model may reclassify each frame of plurality of frames being at least one of consistent or inconsistent, based on a determination each frame of the plurality of frames is determined to be consistent.

Further at operation 719, when the motion is determined to be real then the input video may be outputted as a real video or a natural video. However, when the motion is determined not to be real, then the localization of the motion may be performed to determine the region of the inconsistency in patch of the segmented frame.

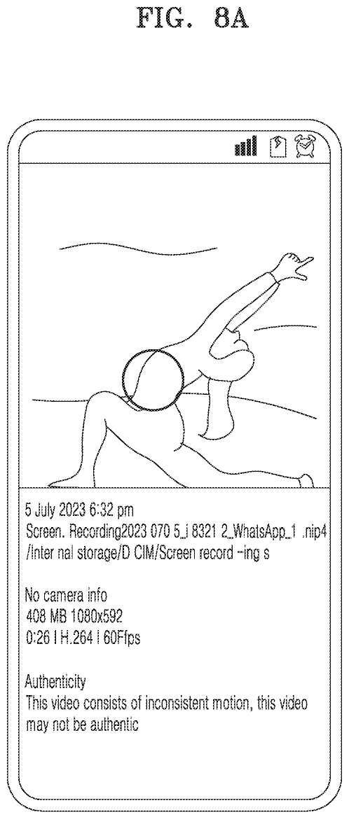

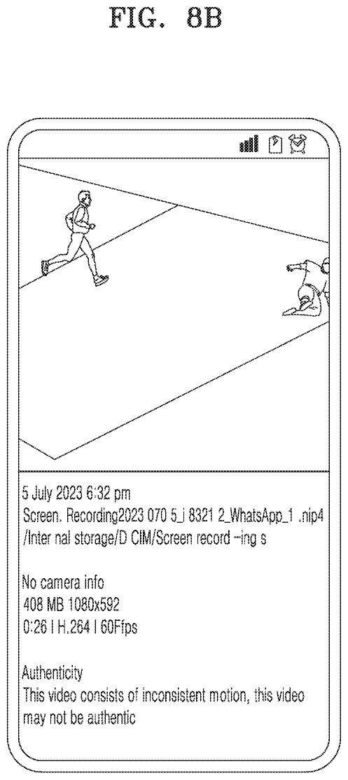

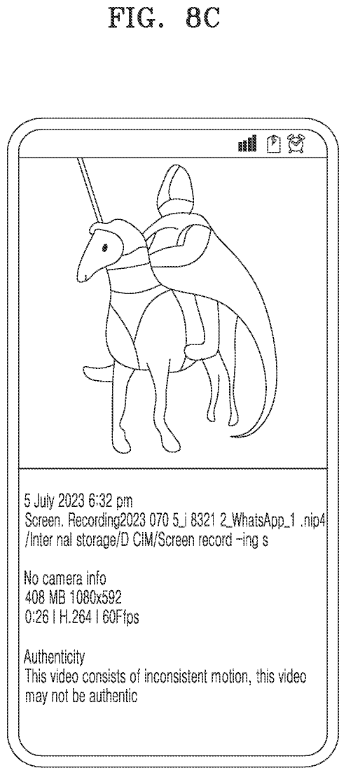

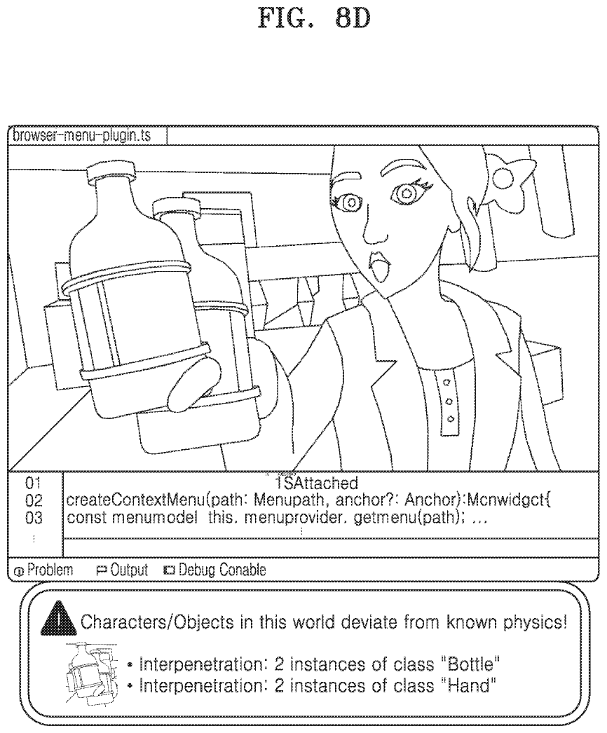

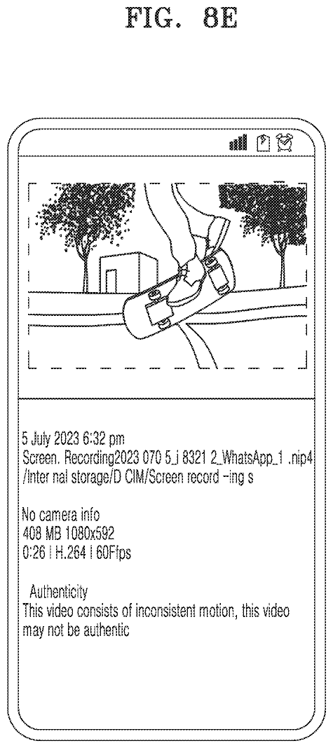

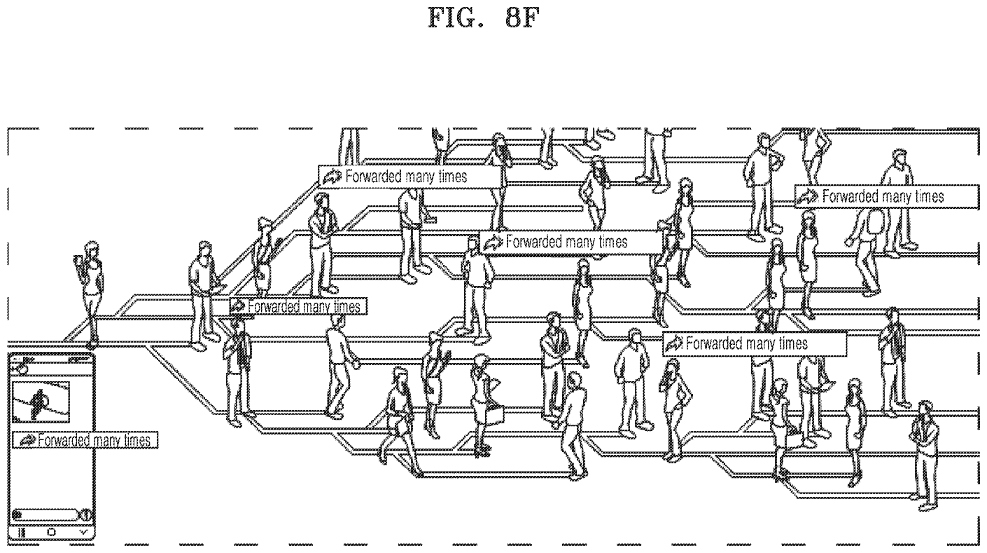

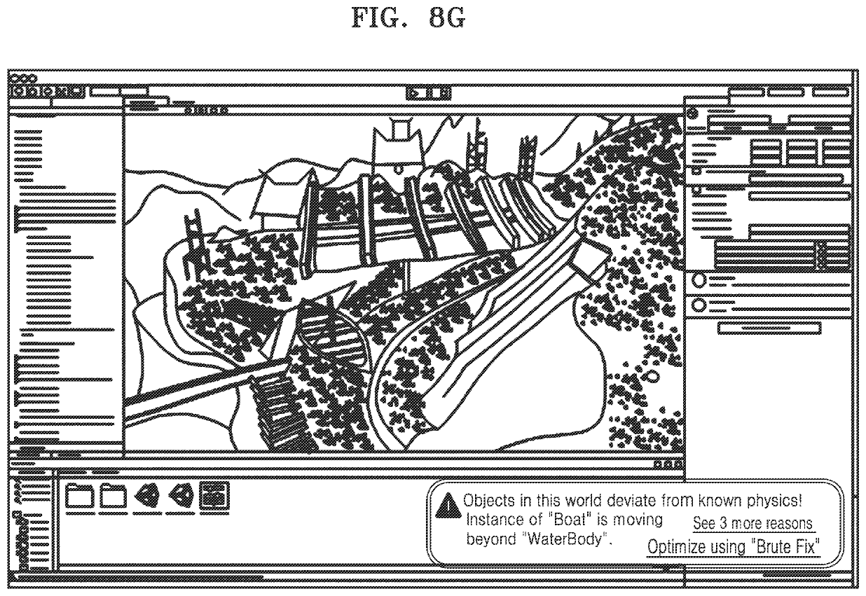

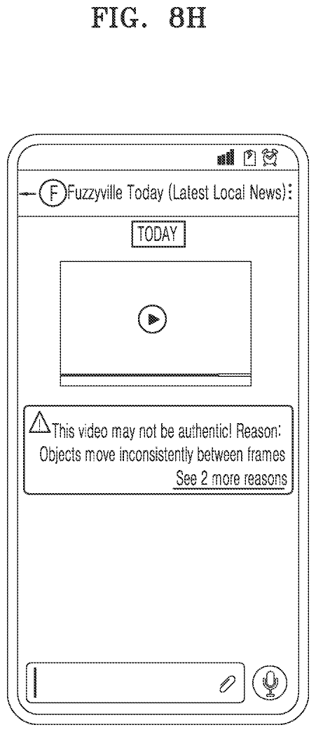

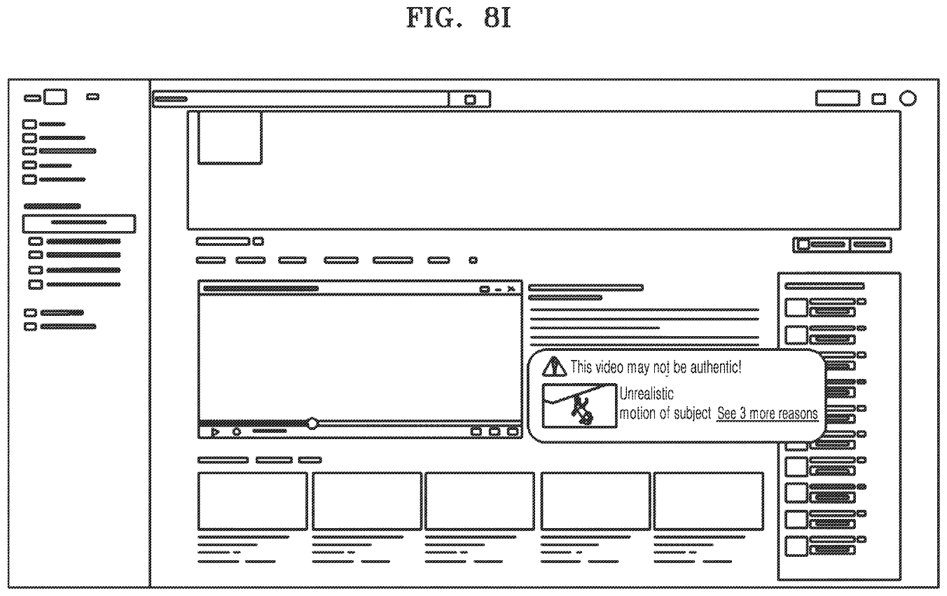

FIG. 8A illustrates a scenario that indicates the inconsistencies or unrealistic lighting patterns where the video frame has been artificially manipulated having the image of the person exercising is overlapped with a sun image. An embodiment of the present disclosure identifies violations of the laws of physics or detect unnatural or physically implausible actions, by monitoring object trajectories, velocities, accelerations, and the interaction of objects. For example, a violation of a law of physic may be detected based on identifying an unnatural motion (e.g., perpetual motion) or an unnatural object (e.g., person holding a mug with two handles). Further, the proposed solution may notify the users the video being inconsistent indicating that the motion in the video is inconsistent and the video may not be authentic.

FIG. 8B indicates, in one or more examples, an electronic device in which a video of a football match is played. Further, the users may be notified by providing notification indicating that the video consists of inconsistent motion (e.g., perpetual motion) along with an indication that the video may not be authentic. For example, the proposed solution may notify the users by a meta data, on swipe-up, such as ‘This video consists of inconsistent motion, this video may not be authentic.’. In an embodiment, this may enable user to be aware before sharing with others and prevent false spreading.

FIG. 8C indicates, in one or more examples, a scene of foot sliding. Further, the users may be notified by providing notification indicating that the video consists of inconsistent motion and the video may not be authentic. For example, the proposed solution may notify the users by a meta data, on swipe-up, such as ‘This video consists of inconsistent motion, this video may not be authentic.’. In an embodiment, this may enable user to be aware before sharing with others and prevent false spreading. It may be possible to identify any violations of the laws of physics or identify (e.g. detect) unnatural or physically implausible actions, by monitoring object trajectories, velocities, accelerations, and the interaction of objects.

FIG. 8D indicates, in one or more examples, a scene that may include violation of the laws of physics by interpenetrations (e.g., mixing together, overlapping, piercing, or blending). Further the users may be notified by providing notification indicating that the video consists of inconsistent motion and the video may not be authentic. For example, the proposed solution may notify the user by a notification such as ‘Characters/Objects in this world deviate from known physics!’, ‘Interpenetration: 2 instances of class “Bottle”’, ‘Interpenetration: 2 instances of class “Hand”’. In an embodiment, the proposed solution may detect and localize inconsistencies during metaverse world design.

As shown in FIG. 8E, the proposed solution may detect the simulations that exhibit one or more behaviors that are physically unrealistic, such as, fluid movements defying gravity or fluid interacting with objects in a way that defies the laws of physics. Fluid flows may not interact convincingly with the environment or objects present in the scene. For example, the fluid might not splash realistically upon impact with a surface or object.

As shown in FIG. 8F, in one or more examples, the users forward the content without being aware of the genuineness and manipulated videos, which may mislead other users with the incorrect information. Further, an embodiment of the present disclosure provide, in one or more examples, the indication of the realness or authenticity of the content in the meta-data (on swipe-up) for the user to check. This may enable the user to be aware of the genuineness and manipulated videos before sharing with others and prevent false spreading.

The FIG. 8G illustrates, in one or more examples, objects in the world that deviate from the known physics. Further, the proposed solution may notify the user of a game studio that the objects are inconsistent and the video may not be authentic. In an embodiment, the proposed solution may identify (e.g. detect, determine) and localize physics violation, and this may minimize brute-force violation during game design. For example, the proposed solution may notify the user by a notification such as ‘Objects in this world deviate from known physics!’, ‘Instance of “Boat” is moving beyond “WaterBody”.’. The user may optimize a game design using “Brute Fix”.

FIG. 8H illustrates, in one or more examples, a scenario of on-device tagging of received videos that indicates the message of the video not being authentic and the objects move inconsistently between the frames. For example, the proposed solution may notify the user by a notification such as ‘This video may not be authentic! Reason: Objects move inconsistently between frames.’.

FIG. 8I illustrates, in one or more examples a scenario of proactive prevention of misleading viral content. The proposed solution provides a warning message to indicate that video is artificial. In an embodiment, if a generated or manipulated video is uploaded to a server by a malicious user, and misleading description is added, server may determine whether the inconsistency of the video is present or not and whether the description imply video is real or not. If inconsistencies are detected and description imply that the video is real, the proposed solution provides a warning message, such as, ‘Artificial video as real violation warning’. In an embodiment, a server may block a channel that uploads misleading viral contents serval times (e.g. 3 times).

The related technologies fall short in a number of ways. The related technologies do not account for the computation of normalized patch-flow to detect subtle subject and action movements. The related technologies do not consider the fusion of cross-modal features and the construction of relationships between visual and motion representations. These approaches are also limited to detecting only facial irregularities using facial and speech feature vectors. Additionally, the related technologies do not include the computation of normalized patch-flow to detect minute subject and action motion, or the fusion of cross-modal features and relationship construction between visual and motion representations. Furthermore, the localization of physically implausible interactions is not explored, and the physical properties of objects such as floating, penetration, timing errors, angular distortions, and gravity are not considered. Further, these methods are limited to facial information, rendering them ineffective for videos without faces or non-human subjects.

Unlike the related technologies, the an embodiment of the present disclosure may offer a method for localizing inconsistent motion in generated videos. This solution may involve patch-wise flow trajectory estimation, cross-modal relation reconstruction, and proper interpretation or analysis of localization to validate whether the content received on a device is authentic or artificially generated. By eliminating inconsistencies such as interpenetrations and foot sliding, this solution may enhance the realism in video games and Metaverse environments. It may provide an intuitive system for detecting AI-generated content by identifying inconsistent motion across multiple frames of a video, a capability that has not been seen in the industry before.

The foregoing description of the specific embodiments may fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It may be to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the embodiments as described herein.

According to an embodiment of the disclosure, the identifying the at least one of object, person, or background in each frame of the plurality of frames of the video may include identifying, by the electronic device, one or more spatial semantics from each frame of the plurality of frames using a CNN model, wherein the one or more spatial semantics are captured as intermediate features for each frame of the plurality of frames. The identifying the at least one of object, person, or background in each frame of the plurality of frames of the video may include detecting, by the electronic device, the at least one of object, person, or background in each frame of the plurality of frames of the video based on the one or more spatial semantics of each frame of the plurality of frames of the video.

According to an embodiment of the disclosure, the identifying the pixel-motion information of each pixel in each frame of the plurality of frames may include dividing, by the electronic device, each frame of the plurality of frames into base patches and centroidal patches, wherein the base patches and centroidal patches comprises the at least one of object, person, or background. The determining the pixel-motion information of each pixel in each frame of the plurality of frames may include identifying, by the electronic device, a patch-wise trajectory of the at least one of object, person, or background in the base patches and centroidal patches of each frame of the plurality of frames. The identifying the pixel-motion information of each pixel in each frame of the plurality of frames may include identifying, by the electronic device, the pixel-motion information of the at least one of object, person, or background across the plurality of frames of the video based on the patch-wise trajectory.

According to an embodiment of the disclosure, the identifying, by the electronic device, the patch-wise trajectory in the base patches and centroidal patches may include identifying, by the electronic device, each of the pixels in the base patches and the centroidal patches of each frame of the plurality of frames. The identifying, by the electronic device, the patch-wise trajectory in the base patches and centroidal patches may include obtaining, by the electronic device, the patch-wise trajectory by performing optical flow normalization in the base patches and the centroidal patches of each frame of the plurality of frames.

According to an embodiment of the disclosure, the identifying the relationship among the at least one of object, person, or background and the corresponding pixel-motion information may include identifying, by the electronic device using an AI model, the relationship in a form of a fused feature map by fusing the information of the at least one of object, person, or background in each patch from each frame of the plurality of frames of the video and the pixel-motion information of the at least one of object, person, or background from the corresponding patch from each frame across the plurality of frames of the video.

According to an embodiment of the disclosure, the identifying the one or more intrinsic properties of the at least one of object, person, or background based on the relationship among the at least one object, person, or background and the corresponding pixel-motion information may include inputting, by the electronic device, a fused feature map to an encoder of AI model. The identifying the one or more intrinsic properties of the at least one of object, person, or background based on the relationship among the at least one object, person, or background and the corresponding pixel-motion information may include learning, by the electronic device, one or more latent vectors by training the encoder of AI model to predict the physical properties of the at least one of object, person, or background detected in the fused feature map, wherein the one or more latent vectors comprise at least one of an energy, a force, a mass, a friction, or a pressure of the at least one of object, person, or background. The identifying the one or more intrinsic properties of the at least one of object, person, or background based on the relationship among the at least one object, person, or background and the corresponding pixel-motion information may include reconstructing, by the electronic device, the fused feature map by the encoder of the AI model to generate a reconstructed feature map. The identifying the one or more intrinsic properties of the at least one of object, person, or background based on the relationship among the at least one object, person, or background and the corresponding pixel-motion information may include identifying, by the electronic device, the one or more intrinsic properties of the at least one of object, person, or background in each frame of plurality of frames based on the reconstructed feature map and the latent vectors, wherein the one or more intrinsic properties comprises at least one of floating, penetration, perpetual motion, energy level, or angular distortion.

According to an embodiment of the disclosure, the identifying, by the electronic device, the inconsistent motion of the at least one of object, person, or background in at least one frame for the plurality of frames of the video may include classifying, by the electronic device, the at least one of object, person, or background in each frame of the plurality of frames being at least one of consistent or inconsistent based on the one or more intrinsic properties of the at least one of object, person, or background. The identifying, by the electronic device, the inconsistent motion of the at least one of object, person, or background in at least one frame for the plurality of frames of the video may include localizing, by the electronic device, an inconsistent region in each frame of plurality of frames using a Convolutional Neural Network (CNN) model, based on a determination that each frame of the plurality of frames is inconsistent. The identifying, by the electronic device, the inconsistent motion of the at least one of object, person, or background in at least one frame for the plurality of frames of the video may include authenticating, by the electronic device, the at least one of object, person, or background in each frame of the plurality of frames using an AI model to reclassify each frame of plurality of frames being at least one of consistent or inconsistent, based on a determination each frame of the plurality of frames is determined to be consistent.

According to an embodiment of the disclosure, the method may include localizing, by the electronic device, a spatial region in the at least one frame based on the inconsistent motion of the at least one of object, person, or background in the at least one frame of the video.

According to an embodiment of the disclosure, the method may include localizing a patch in the at least one frame based on the inconsistent motion of the at least one of object, person, or background in the at least one frame of the video. The localizing the patch may include identifying, by the electronic device, one or more class activation maps by backtracking in intermediate convolution layers of the CNN model which caused decision of classification based on gradient between output layer of the CNN model and the convolved feature maps from the intermediate layers of the CNN mode. The localizing the patch may include localizing, by the electronic device, the patch in the at least one frame which activated signal for classifying as inconsistent based on the identified one or more class activation maps.

According to an embodiment of the disclosure, the authenticating the fused feature map of each frame of the plurality of frames may include detecting, by the electronic device, the at least one object, person, or background in each frame of the plurality of frames of the video. The authenticating the fused feature map of each frame of the plurality of frames may include authenticating, by the electronic device, the fused feature map of each frame by classifying the at least one object, person, or background being at least one of consistent or inconsistent using the AI model. The AI model may analyze the at least one object, person, or background in each frame of the plurality of frames of the video.

According to an embodiment of the disclosure, the electronic device, to identify the at least one of object, person, or background in each frame of the plurality of frames of the video, may include the one or more processors which are configured to execute the instructions to identify one or more spatial semantics from each frame of the plurality of frames using a CNN model. The one or more spatial semantics may be captured as intermediate features for each frame of the plurality of frames. The electronic device, to identify the at least one of object, person, or background in each frame of the plurality of frames of the video, may include the one or more processors which are configured to execute the instructions to detect the at least one of object, person, or background in each frame of the plurality of frames of the video based on the one or more spatial semantics of each frame of the plurality of frames of the video.

According to an embodiment of the disclosure, the electronic device, to identify the pixel-motion information of each pixel in each frame of the plurality of frames, may include the one or more processors which are configured to execute the instructions to segment each frame of the plurality of frames into base patches and centroidal patches. The electronic device, to identify the pixel-motion information of each pixel in each frame of the plurality of frames, may include the one or more processors which are configured to execute the instructions to identify a patch-wise trajectory of the at least one of object, person, or background in the base patches and centroidal patches, wherein the base patches and centroidal patches comprises at least one of object, person, or background. The electronic device, to identify the pixel-motion information of each pixel in each frame of the plurality of frames, may include the one or more processors which are configured to execute the instructions to identify the pixel-motion information of the at least one of object, person, or background across the plurality of frames of the video based on the patch-wise trajectory.

According to an embodiment of the disclosure, the electronic device, to identify the patch-wise trajectory in the base patches and centroidal patches, may include the one or more processors which are further configured to execute the instructions to track each of the pixels in the base patches and the centroidal patches of each frame of the plurality of frames. The electronic device, to identify the patch-wise trajectory in the base patches and centroidal patches, may include the one or more processors which are configured to execute the instructions to obtain patch-wise trajectory by performing optical flow normalization in the base patches and the centroidal patches of each frame of the plurality of frames.

According to an embodiment of the disclosure, the electronic device, to identify the relationship among the at least one of object, person, or background and the corresponding pixel-motion information, may include the one or more processor which are further configured to execute the instructions to determine, using an AI model, the relationship in a form of a fused feature map by fusing the information of the at least one of object, person, or background in each patch from each frame of the plurality of frames of the video and the pixel-motion information of the at least one of object, person, or background from the corresponding patch from each frame across the plurality of frames of the video.

According to an embodiment of the disclosure, the electronic device, to identify the one or more intrinsic properties of the at least one of object, person, or background based on the relationship among the at least one of object, person, or background, and the corresponding pixel-motion information, may include the one or more processors which are configured to execute the instructions to input a fused feature map to an encoder of AI model.

According to an embodiment of the disclosure, the electronic device, to identify the one or more intrinsic properties of the at least one of object, person, or background based on the relationship among the at least one of object, person, or background, and the corresponding pixel-motion information, may include the one or more processors which are configured to execute the instructions to learn one or more latent vectors by training the encoder of the AI model to predict the physical properties of the at least one of object, person, or background detected in the fused feature map. The one or more latent vectors may include at least one of an energy, a force, a mass, a friction, or a pressure of the at least one of object, person, or background. The electronic device, to identify the one or more intrinsic properties of the at least one of object, person, or background based on the relationship among the at least one of object, person, or background, and the corresponding pixel-motion information, may include the one or more processors which are configured to execute the instructions to reconstruct the fused feature map by the encoder of the AI model to generate a reconstructed featured map. The electronic device, to identify the one or more intrinsic properties of the at least one of object, person, or background based on the relationship among the at least one of object, person, or background, and the corresponding pixel-motion information, may include the one or more processors which are further configured to execute the instructions to identify the one or more intrinsic properties of the at least one of object, person, or background in each frame of plurality of frames based on the reconstructed feature map and the latent vectors. The one or more intrinsic properties may include at least one of floating, penetration, perpetual motion, energy level, or angular distortions.

According to an embodiment of the disclosure, the electronic device, to identify the inconsistent motion of the at least one of object, person, or background in at least one frame for the plurality of frames of the video, may include the one or more processors which are further configured to execute the instructions to classify the at least one of object, person, or background in each frame of the plurality of frames being at least one of consistent or inconsistent based on the one or more intrinsic properties of the at least one of object, person, or background. The electronic device, to identify the inconsistent motion of the at least one of object, person, or background in at least one frame for the plurality of frames of the video, may include the one or more processors which are further configured to execute the instructions to localize an inconsistent region in each frame of plurality of frames using a Convolutional Neural Network (CNN) model, based on a determination that each frame of the plurality of frames is inconsistent. The electronic device, to identify the inconsistent motion of the at least one of object, person, or background in at least one frame for the plurality of frames of the video, may include the one or more processors which are configured to execute the instructions to authenticate the at least one identified spatial context in each frame of the plurality of frames using the AI model to reclassify each frame of the plurality of frames being at least one of consistent or inconsistent, based on a determination each frame of the plurality of frames is determined to be consistent.

The electronic device may include the one or more processors which are configured to localize a spatial region in the at least one frame based on the inconsistent motion of the at least one of object, person, or background in the at least one frame of the video.

The electronic device, to localize a patch in the at least one frame based on the inconsistent motion of the at least one object, person, or background in the at least one frame of the video, may include the one or more processors which are configured to identify a one or more class activation maps by backtracking in intermediate convolution layers of the CNN model which caused decision of classification based on gradient between output layer of the CNN model and the convolved feature maps from the intermediate layers of the CNN model. The electronic device, to localize a patch in the at least one frame based on the inconsistent motion of the at least one object, person, or background in the at least one frame of the video, may include the one or more processors which are configured to localize the patch in the at least one frame which activated signal for classifying as inconsistent based on the identified one or more class activation maps.

The electronic device, to authenticate the fused feature map of each frame of the plurality of frame, may include the one or more processors which are configured to detect the at least one object, the at least one person, and the at least one background in each frame of the plurality of frames of the video using spatial information extraction model. The electronic device, to authenticate the fused feature map of each frame of the plurality of frame, may include the one or more processors which are configured to authenticate the fused feature map of each frame by classifying the at least one object, person, and background being at least one of consistent or inconsistent using the AI model. The AI model may analyze the at least one object, person, and background in each frame of the plurality of frames of the video.

What is claimed is:

1. A method for detecting artificial intelligence (AI) generated content in a video, comprising:
obtaining, by an electronic device, the video comprising a plurality of frames;
identifying, by the electronic device, at least one of object, person, or background in each frame of the plurality of frames of the video;
identifying, by the electronic device, pixel-motion information of each pixel in each frame of the plurality of frames;
identifying, by the electronic device, a relationship among the at least one of object, person, or background and the corresponding pixel-motion information in each frame of the plurality of frames;
identifying, by the electronic device, one or more intrinsic properties of the at least one of object, person, or background in each frame of plurality of frames based on the relationship among the at least one of object, person, or background and the corresponding pixel-motion information;
identifying, by the electronic device, inconsistent motion of the at least one of object, person, or background in at least one frame of the plurality of frames of the video based on the one or more intrinsic properties of the at least one of object, person, or background; and
displaying, by the electronic device, AI generated content in the at least one frame of the plurality of frames of the video based on the identified inconsistent motion of the at least one of object, person, or background in at least one frame of the plurality of frames of the video.

2. The method as claimed in claim 1, wherein the identifying the at least one of object, person, or background in each frame of the plurality of frames of the video comprises:
identifying, by the electronic device, one or more spatial semantics from each frame of the plurality of frames using a CNN model, wherein the one or more spatial semantics are captured as intermediate features for each frame of the plurality of frames; and
identifying, by the electronic device, the at least one of object, person, or background in each frame of the plurality of frames of the video based on the one or more spatial semantics of each frame of the plurality of frames of the video.

3. The method as claimed in claim 1, wherein the identifying the pixel-motion information of each pixel in each frame of the plurality of frames comprises:
dividing, by the electronic device, each frame of the plurality of frames into base patches and centroidal patches, wherein the base patches and centroidal patches comprises the at least one of object, person, or background;
identifying, by the electronic device, a patch-wise trajectory of the at least one of object, person, or background in the base patches and centroidal patches of each frame of the plurality of frames; and
identifying, by the electronic device, the pixel-motion information of the at least one of object, person, or background across the plurality of frames of the video based on the patch-wise trajectory.

4. The method as claimed in claim 3, wherein the identifying, by the electronic device, the patch-wise trajectory in the base patches and centroidal patches comprises:
identifying, by the electronic device, each of the pixels in the base patches and the centroidal patches of each frame of the plurality of frames; and
obtaining, by the electronic device, the patch-wise trajectory by performing optical flow normalization in the base patches and the centroidal patches of each frame of the plurality of frames.

5. The method as claimed in claim 1, wherein the identifying the relationship among the at least one of object, person, or background and the corresponding pixel-motion information comprises:
identifying, by the electronic device using an AI model, the relationship in a form of a fused feature map by fusing the information of the at least one of object, person, or background in each patch from each frame of the plurality of frames of the video and the pixel-motion information of the at least one of object, person, or background from the corresponding patch from each frame across the plurality of frames of the video.

6. The method as claimed in claim 1, wherein the identifying the one or more intrinsic properties of the at least one of object, person, or background based on the relationship among the at least one object, person, or background and the corresponding pixel-motion information comprises:
inputting, by the electronic device, a fused feature map to an encoder of AI model;
learning, by the electronic device, one or more latent vectors by training the encoder of AI model to predict the physical properties of the at least one of object, person, or background identified in the fused feature map, wherein the one or more latent vectors comprise at least one of an energy, a force, a mass, a friction, or a pressure of the at least one of object, person, or background;
reconstructing, by the electronic device, the fused feature map by the encoder of the AI model to generate a reconstructed feature map; and
identifying, by the electronic device, the one or more intrinsic properties of the at least one of object, person, or background in each frame of plurality of frames based on the reconstructed feature map and the latent vectors, wherein the one or more intrinsic properties comprises at least one of floating, penetration, perpetual motion, energy level, or angular distortions.

7. The method as claimed in claim 1, wherein the identifying, by the electronic device, the inconsistent motion of the at least one of object, person, or background in at least one frame for the plurality of frames of the video comprises:
identifying, by the electronic device, the at least one of object, person, or background in each frame of the plurality of frames being at least one of consistent or inconsistent based on the one or more intrinsic properties of the at least one of object, person, or background;
localizing, by the electronic device, an inconsistent region in each frame of plurality of frames using a Convolutional Neural Network (CNN) model, based on a determination that each frame of the plurality of frames is inconsistent.

8. The method as claimed in claim 1, wherein the detecting, by the electronic device, the inconsistent motion of the at least one of object, person, or background in at least one frame for the plurality of frames of the video comprises:
classifying, by the electronic device, the at least one of object, person, or background in each frame of the plurality of frames being at least one of consistent or inconsistent based on the one or more intrinsic properties of the at least one of object, person, or background;
authenticating, by the electronic device, the at least one of object, person, or background in each frame of the plurality of frames using an AI model to reclassify each frame of plurality of frames being at least one of consistent or inconsistent, based on a determination each frame of the plurality of frames is determined to be consistent.

9. The method as claimed in claim 1, further comprising:
localizing, by the electronic device, a spatial region in the at least one frame based on the inconsistent motion of the at least one of object, person, or background in the at least one frame of the video.

10. The method as claimed in claim 1, further comprising localizing a patch in the at least one frame based on the inconsistent motion of the at least one of object, person, or background in the at least one frame of the video, the localizing the patch comprising:
identifying, by the electronic device, one or more class activation maps by backtracking in intermediate convolution layers of the CNN model which caused decision of classification based on gradient between output layer of the CNN model and the convolved feature maps from the intermediate layers of the CNN model; and
localizing, by the electronic device, the patch in the at least one frame which activated signal for classifying as inconsistent based on the identified one or more class activation maps.

11. An electronic device for detecting artificial intelligence (AI) generated content in a video, comprising:
one or more memories storing instructions;
one or more processors communicatively coupled to the memory; wherein the one or more processors are configured to execute the instructions to:
obtain the video comprising a plurality of frames;
identify at least one of object, person, or background in each frame of the plurality of frames of the video;
identify pixel-motion information of each pixel in each frame of the plurality of frames;
identify a relationship among the at least one of object, person, or background and the corresponding pixel-motion information in each frame of the plurality of frame;
identify one or more intrinsic properties of the at least one of object, person, or background in each frame of plurality of frames based on the relationship among the at least one object, person, or background and the corresponding pixel-motion information;
identify inconsistent motion of the at least one of object, person, or background in at least one frame for the plurality of frames of the video based on the one or more intrinsic properties of the at least one of object, person, or background; and
display AI generated content in the at least one frame of the plurality of frames of the video based on the identified inconsistent motion of the at least one of object, person, or background in at least one frame of the plurality of frames of the video.

12. The electronic device as claimed in claim 11, wherein to identify the at least one of object, person, or background in each frame of the plurality of frames of the video, the one or more processors are further configured to execute the instructions to:
identify one or more spatial semantics from each frame of the plurality of frames using a CNN model, wherein the one or more spatial semantics are captured as intermediate features for each frame of the plurality of frames; and
identify the at least one of object, person, or background in each frame of the plurality of frames of the video based on the one or more spatial semantics of each frame of the plurality of frames of the video.

13. The electronic device as claimed in claim 11, wherein to identify the pixel-motion information of each pixel in each frame of the plurality of frames, the one or more processors are further configured to execute the instructions to:
divide each frame of the plurality of frames into base patches and centroidal patches;
identify a patch-wise trajectory of the at least one of object, person, or background in the base patches and centroidal patches, wherein the base patches and centroidal patches comprises at least one of object, person, or background; and
identify the pixel-motion information of the at least one of object, person, or background across the plurality of frames of the video based on the patch-wise trajectory.

14. The electronic device as claimed in claim 13, wherein to identify the patch-wise trajectory in the base patches and centroidal patches, the one or more processors are further configured to execute the instructions to:
identify each of the pixels in the base patches and the centroidal patches of each frame of the plurality of frames; and
obtain patch-wise trajectory by performing optical flow normalization in the base patches and the centroidal patches of each frame of the plurality of frames.

15. The electronic device as claimed in claim 11, wherein to identify the relationship among the at least one of object, person, or background and the corresponding pixel-motion information, the one or more processor are further configured to execute the instructions to:
identify, using an AI model, the relationship in a form of a fused feature map by fusing the information of the at least one of object, person, or background in each patch from each frame of the plurality of frames of the video and the pixel-motion information of the at least one of object, person, or background from the corresponding patch from each frame across the plurality of frames of the video.

16. The electronic device as claimed in claim 11, wherein to identify the one or more intrinsic properties of the at least one of object, person, or background based on the relationship among the at least one of object, person, or background, and the corresponding pixel-motion information, the one or more processors are further configured to execute the instructions to:
input a fused feature map to an encoder of AI model;
learn one or more latent vectors by training the encoder of the AI model to predict the physical properties of the at least one of object, person, or background identified in the fused feature map, wherein the one or more latent vectors comprises at least one of an energy, a force, a mass, a friction, or a pressure of the at least one of object, person, or background;
reconstruct the fused feature map by the encoder of the AI model to generate a reconstructed featured map; and
identify the one or more intrinsic properties of the at least one of object, person, or background in each frame of plurality of frames based on the reconstructed feature map and the latent vectors, wherein the one or more intrinsic properties comprises at least one of floating, penetration, perpetual motion, energy level, or angular distortions.

17. The electronic device as claimed in claim 11, wherein to identify the inconsistent motion of the at least one of object, person, or background in at least one frame for the plurality of frames of the video, the one or more processors are further configured to execute the instructions to:
classify the at least one of object, person, or background in each frame of the plurality of frames being at least one of consistent or inconsistent based on the one or more intrinsic properties of the at least one of object, person, or background;
localize an inconsistent region in each frame of plurality of frames using a Convolutional Neural Network (CNN) model, based on a determination that each frame of the plurality of frames is inconsistent.

18. The electronic device as claimed in claim 11, wherein to identify the inconsistent motion of the at least one of object, person, or background in at least one frame for the plurality of frames of the video, the at one or more processors are further configured to execute the instructions to:
classify the at least one of object, person, or background in each frame of the plurality of frames being at least one of consistent or inconsistent based on the one or more intrinsic properties of the at least one of object, person, or background;
authenticate the at least one identified spatial context in each frame of the plurality of frames using the AI model to reclassify each frame of the plurality of frames being at least one of consistent or inconsistent, based on a determination each frame of the plurality of frames is determined to be consistent.

19. The electronic device as claimed in claim 11, the one or more processors are configured to:
localize a spatial region in the at least one frame based on the inconsistent motion of the at least one of object, person, or background in the at least one frame of the video.

20. A non-transitory computer-readable storage medium storing instructions that, when executed by at least one processor, cause the at least one processor to:
obtain the video comprising a plurality of frames;
identify at least one of object, person, or background in each frame of the plurality of frames of the video;
identify pixel-motion information of each pixel in each frame of the plurality of frames;
identify a relationship among the at least one of object, person, or background and the corresponding pixel-motion information in each frame of the plurality of frame;
identify one or more intrinsic properties of the at least one of object, person, or background in each frame of plurality of frames based on the relationship among the at least one object, person, or background and the corresponding pixel-motion information;
identify inconsistent motion of the at least one of object, person, or background in at least one frame for the plurality of frames of the video based on the one or more intrinsic properties of the at least one of object, person, or background; and
display AI generated content in the at least one frame of the plurality of frames of the video based on the identified inconsistent motion of the at least one of object, person, or background in at least one frame of the plurality of frames of the video.
